(19) United States
(12) Patent Application Publication
(10) Pub. No.: US 2024/0104987 A1
(43) Pub. Date: Mar. 28, 2024

(54) INFORMATION PROCESSING APPARATUS, INFORMATION PROCESSING SYSTEM, INFORMATION PROCESSING METHOD, AND NON-TRANSITORY COMPUTER-READABLE MEDIUM

(71) Applicant: NEC Corporation, Minato-ku, Tokyo (JP)

(72) Inventors: Hiroshi Osada, Tokyo (JP); Osamu Sakaguchi, Tokyo (JP); Toshimasa Niiya, Tokyo (JP)

(73) Assignee: NEC Corporation, Minato-ku, Tokyo (JP)

(21) Appl. No.: 18/276,185

(22) PCT Filed: Dec. 13, 2021
(86) PCT No.: PCT/JP2021/045845

§ 371 Date: Aug. 7, 2023

(30) Foreign Application Priority Data
Feb. 25, 2021 (JP) 2021-029274

(51) Int. Cl. G07C 9/00

(52) U.S. Cl. CPC G07C 9/00563

(57) ABSTRACT

An information processing apparatus includes a registration unit, an acquisition unit, an authentication control unit, and a gate control unit. The registration unit registers first appearance information for registration in association with face information for registration for each registration target person, and updates the first appearance information. The acquisition unit acquires captured image data obtained by imaging an authentication target person. The authentication control unit performs personal authentication of the authentication target person based on a first and a second determination result. The first determination result indicates whether or not face information based on the captured image data corresponds to the face information for registration. The second determination result indicates whether or not first appearance information based on the captured image data corresponds to the first appearance information for registration. In a case where the personal authentication has succeeded, the gate control unit permits passage through a gate.

### TECHNICAL FIELD

The present disclosure relates to an information processing apparatus, an information processing system, an information processing method, and a non-transitory computer-readable medium.

### BACKGROUND ART

In recent years, an image recognition technology has been developed, and authentication by image recognition has attracted attention. Further, multi-factor authentication by image recognition has been proposed in order to secure authentication accuracy while securing user convenience. For example, Patent Literature 1 discloses an information processing apparatus that performs face identification based on a face image of an authentication target person, recognizes a password generated based on a motion of lips of the authentication target person, and performs personal authentication based on a result of the face identification and a result of the password recognition. Patent Literature 2 discloses an image forming apparatus that performs face recognition and gesture recognition, performs authentication based on a result of the face recognition and a result of the gesture recognition, and starts security printing in a case where the authentication has succeeded.

### CITATION LIST

### Patent Literature

Patent Literature 1: Japanese Unexamined Patent Application Publication No. 2011-203992
Patent Literature 2: Japanese Unexamined Patent Application Publication No. 2016-018264

### SUMMARY OF INVENTION

### Technical Problem

However, in the technologies described in Patent Literatures 1 and 2 described above, when an authentication motion is made in a place where there is a person around, such as an entrance/exit gate, there is a possibility that the authentication motion is known to the surroundings. Furthermore, in such a case, when image recognition for a plurality of factors is performed in a state where there is a person around, there is a possibility of causing false recognition.

In view of the above-described problems, an object of the present disclosure is to provide an information processing apparatus that suitably performs multi-factor authentication using image recognition, an information processing system, an information processing method, and a non-transitory computer-readable medium.

### Solution to Problem

An information processing apparatus according to an aspect of the present disclosure includes:
registration means for registering first appearance information for registration in association with face information for registration for each registration target person, and updating the first appearance information for registration associated with the face information for registration in a case where a predetermined condition is satisfied;
acquisition means for acquiring captured image data obtained by imaging an authentication target person;
authentication control means for performing personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration; and
gate control means for permitting passage through a gate in a case where the personal authentication has succeeded.

An information processing system according to an aspect of the present disclosure includes:
an authentication terminal configured to generate a captured image obtained by imaging an authentication target person; and
an information processing apparatus communicably connected to the authentication terminal.

The information processing apparatus includes:
registration means for registering first appearance information for registration in association with face information for registration for each registration target person, and updating the first appearance information for registration associated with the face information for registration in a case where a predetermined condition is satisfied;
acquisition means for acquiring captured image data obtained by imaging an authentication target person;
authentication control means for performing personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration; and
gate control means for permitting passage through a gate in a case where the personal authentication has succeeded.

An information processing method according to an aspect of the present disclosure includes:
registering first appearance information for registration in association with face information for registration for each registration target person;
acquiring captured image data obtained by imaging an authentication target person;
performing personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration;
permitting passage through a gate in a case where the personal authentication has succeeded; and
updating the first appearance information for registration associated with the face information for registration in a case where a predetermined condition is satisfied for each registration target person.

A non-transitory computer-readable medium according to an aspect of the present disclosure stores a program that causes a computer to execute:
registering first appearance information for registration in association with face information for registration for each registration target person;
acquiring captured image data obtained by imaging an authentication target person;
performing personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration;
permitting passage through a gate in a case where the personal authentication has succeeded; and
updating the first appearance information for registration associated with the face information for registration in a case where a predetermined condition is satisfied for each registration target person.

### Advantageous Effects of Invention

According to the present disclosure, it is possible to provide an information processing apparatus that suitably performs multi-factor authentication using image recognition, an information processing system, an information processing method, and a non-transitory computer-readable medium.

### BRIEF DESCRIPTION OF DRAWINGS

FIG. 1 is a block diagram illustrating a configuration of an information processing apparatus according to a first example embodiment.

FIG. 2 is a diagram illustrating a flow of an information processing method according to the first example embodiment.

FIG. 3 is a block diagram illustrating an overall configuration of an information processing system according to a second example embodiment.

FIG. 4 is a block diagram illustrating a configuration of a face authentication apparatus according to the second example embodiment.

FIG. 5 is a flowchart illustrating a flow of face information registration processing according to the second example embodiment.

FIG. 6 is a flowchart illustrating a flow of face authentication processing according to the second example embodiment.

FIG. 7 is a block diagram illustrating a configuration of an appearance authentication apparatus according to the second example embodiment.

FIG. 8 is a flowchart illustrating a flow of appearance authentication processing according to the second example embodiment.

FIG. 9 is a block diagram illustrating a configuration of an authentication terminal according to the second example embodiment.

FIG. 10 is a block diagram illustrating a configuration of a user terminal according to the second example embodiment.

FIG. 11 is a block diagram illustrating a configuration of an information processing apparatus according to the second example embodiment.

FIG. 12 is a diagram illustrating an example of a data structure of registration history information according to the second example embodiment.

FIG. 13 is a diagram illustrating an example of a data structure of authentication history information according to the second example embodiment.

FIG. 14 is a flowchart illustrating a flow of registration processing according to the second example embodiment.

FIG. 15 is a flowchart illustrating a flow of personal authentication processing according to the second example embodiment.

FIG. 16 is a flowchart illustrating a flow of appearance information update processing according to the second example embodiment.

FIG. 17 is a sequence diagram illustrating a flow of the registration processing according to the second example embodiment.

FIG. 18 is a view illustrating an example of display on the user terminal according to the second example embodiment.

FIG. 19 is a sequence diagram illustrating a flow of the personal authentication processing according to the second example embodiment.

FIG. 20 is a view for describing an example of the personal authentication processing according to the second example embodiment.

FIG. 21 is a view for describing an example of the personal authentication processing according to the second example embodiment.

FIG. 22 is a view for describing an example of the personal authentication processing according to the second example embodiment.

FIG. 23 is a sequence diagram illustrating a flow of update processing according to the second example embodiment.

FIG. 24 is a view illustrating an example of display on the user terminal according to the second example embodiment.

FIG. 25 is a block diagram illustrating a configuration of an appearance authentication apparatus according to a third example embodiment.

FIG. 26 is a flowchart illustrating a flow of appearance authentication processing according to the third example embodiment.

FIG. 27 is a diagram illustrating an example of a data structure of registration history information according to the third example embodiment.

FIG. 28 is a flowchart illustrating a flow of factor addition processing according to the third example embodiment.

FIG. 29 is a flowchart illustrating a flow of personal authentication processing according to the third example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated description is omitted as necessary for clarity of description.

### First Example Embodiment

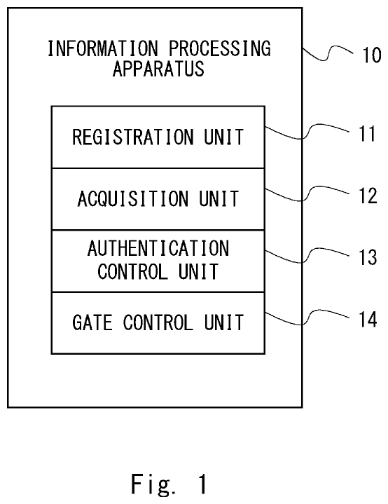

First, a first example embodiment of the present disclosure will be described. FIG. 1 is a block diagram illustrating a configuration of an information processing apparatus 10 according to the first example embodiment. The information processing apparatus 10 is an information processing apparatus that performs multi-factor authentication. Here, the information processing apparatus 10 is connected to a network (not illustrated). The network may be a wired network or a wireless network. In addition, a gate driving apparatus (not illustrated) that opens and closes a gate and an authentication terminal (not illustrated) that is installed near the gate and images an authentication target person to generate a captured image are connected to the network. That is, the information processing apparatus 10 is communicably connected to the gate driving apparatus and the authentication terminal via the network. The captured image includes at least a face region of the target person.

The information processing apparatus 10 includes a registration unit 11, an acquisition unit 12, an authentication control unit 13, and a gate control unit 14.

The registration unit 11 is also referred to as registration means. The registration unit 11 registers appearance information for registration in association with face information for registration for each registration target person. Here, the appearance information is also referred to as first appearance information, and is information indicating an appearance of the target person at the time of authentication. It is preferable that the appearance in the appearance information can be easily changed by the target person's own will. For example, the appearance information may be motion information indicating a gesture (motion) of the target person at the time of authentication or clothing information indicating clothing of the target person at the time of authentication. Then, in a case where a predetermined condition is satisfied for each registration target person, the registration unit 11 updates the appearance information for registration associated with the face information for registration.

The acquisition unit 12 is also referred to as acquisition means. The acquisition unit 12 acquires captured image data obtained by capturing the authentication target person from the authentication terminal via the network. Then, the acquisition unit 12 supplies the captured image data to the authentication control unit 13.

The authentication control unit 13 is also referred to as authentication control means. The authentication control unit 13 performs personal authentication of the authentication target person based on first and second determination results based on the captured image data. Here, the first determination result indicates whether or not face information for authentication generated based on the captured image data corresponds to the face information for registration. Therefore, the first determination result may be referred to as a face authentication result or a face determination result. The second determination result indicates whether or not appearance information for authentication generated based on the captured image data corresponds to the appearance information for registration. Therefore, the second determination result may be referred to as an appearance authentication result or an appearance determination result. The authentication control unit 13 supplies a result of the personal authentication to the gate control unit 14.

The gate control unit 14 is also referred to as gate control means. In a case where the personal authentication has succeeded, the gate control unit 14 permits passage of the authentication target person through the gate. For example, in a case where the personal authentication has succeeded, the gate control unit 14 transmits a control signal for opening the gate to the gate driving apparatus via the network. In addition, for example, in a case where the personal authentication has failed, the gate control unit 14 transmits a control signal for closing the gate to the gate driving apparatus via the network. In addition, for example, in a case where the personal authentication has succeeded, the gate control unit 14 transmits, via the network, a control signal for causing the gate driving apparatus to output (for example, display or output as sound) an indication to permit passage through the gate. In addition, for example, in a case where the personal authentication has failed, the gate control unit 14 transmits, via the network, a control signal for causing the gate driving apparatus to output an indication to restrict passage through the gate.

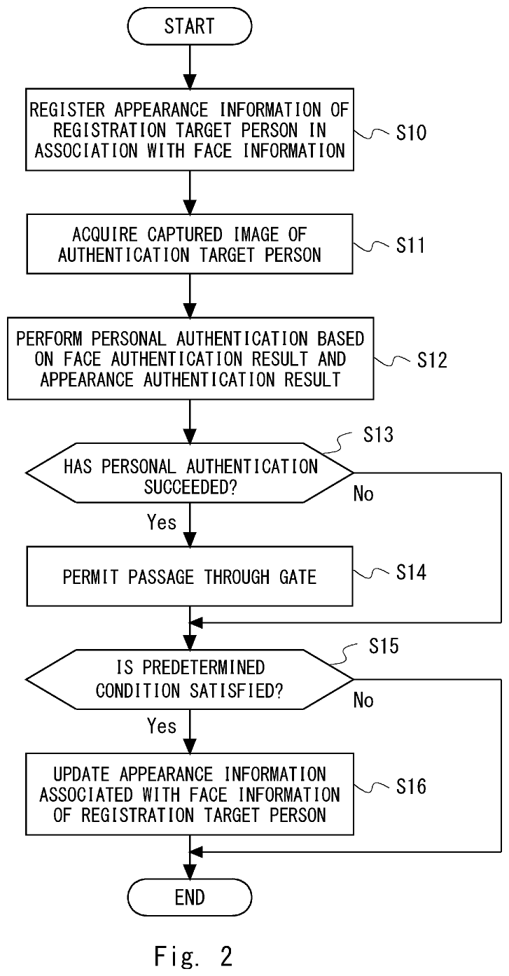

FIG. 2 is a diagram illustrating a flow of an information processing method according to the first example embodiment. First, the registration unit 11 registers appearance information of a registration target person in association with face information of the registration target person (S10). Subsequently, the acquisition unit 12 acquires captured image data obtained by capturing an authentication target person from the authentication terminal via the network (S11). Subsequently, the authentication control unit 13 performs personal authentication based on a face authentication result and an appearance authentication result (S12), and determines whether or not the personal authentication has succeeded (S13). Specifically, in a case where the face authentication has succeeded and the appearance authentication has succeeded, the authentication control unit 13 determines that the personal authentication has succeeded. On the other hand, in a case where any one of the face authentication and the appearance authentication has failed, the authentication control unit 13 determines that the personal authentication has failed. In a case where the authentication control unit 13 determines that the personal authentication has succeeded (Yes in S13), the gate control unit 14 permits passage of the authentication target person through the gate (S14), and the processing proceeds to step S15. On the other hand, in a case where the authentication control unit 13 determines that the personal authentication has failed (No in S13), the processing proceeds to step S15. In step S5, the registration unit 11 determines whether or not a predetermined condition is satisfied (S15). In a case where it is determined that the predetermined condition is satisfied (Yes in S15), the registration unit 11 updates the appearance information associated with the face information of the registration target person to new appearance information (S16).

As described above, the information processing apparatus 10 according to the first example embodiment performs multi-factor authentication for the face authentication and the appearance authentication by using image recognition, and updates the appearance information related to the appearance authentication in a case where a predetermined condition is satisfied. Therefore, it is possible to improve a security level by reducing a risk in a case where personal information called the appearance information is leaked while improving the authentication accuracy by using the multi-factor authentication. This is particularly effective in a case where personal authentication is performed in a place where there is a person around. As a result, the information processing apparatus 10 can suitably perform the multi-factor authentication using image recognition.

Note that the information processing apparatus 10 includes a processor, a memory, and a storage device as components not illustrated. Furthermore, the storage device stores a computer program in which processing of the information processing method according to the present example embodiment is implemented. Then, the processor reads a computer program from the storage device into the memory, and executes the computer program. As a result, the processor implements the functions of the registration unit 11, the acquisition unit 12, the authentication control unit 13, and the gate control unit 14.

Alternatively, each of the registration unit 11, the acquisition unit 12, the authentication control unit 13, and the gate control unit 14 may be implemented by dedicated hardware. In addition, some or all of the components of each apparatus may be implemented by general-purpose or dedicated circuitry, a processor, or the like, or a combination thereof. These may be implemented by a single chip or may be implemented by a plurality of chips connected via a bus. Some or all of components of each apparatus may be implemented by a combination of the above-described circuit or the like and a program. Furthermore, a central processing unit (CPU), a graphics processing unit (GPU), a field-programmable gate array (FPGA), or the like can be used as the processor.

Furthermore, in a case where some or all of the components of the information processing apparatus 10 are implemented by a plurality of information processing apparatuses, circuits, and the like, the plurality of information processing apparatuses, circuits, and the like may be arranged in a centralized manner or in a distributed manner. For example, the information processing apparatus, the circuit, and the like may be implemented as a form in which each is connected via a communication network, such as a client server system and a cloud computing system. Furthermore, the function of the information processing apparatus 10 may be provided in a software as a service (SaaS) format.

### Second Example Embodiment

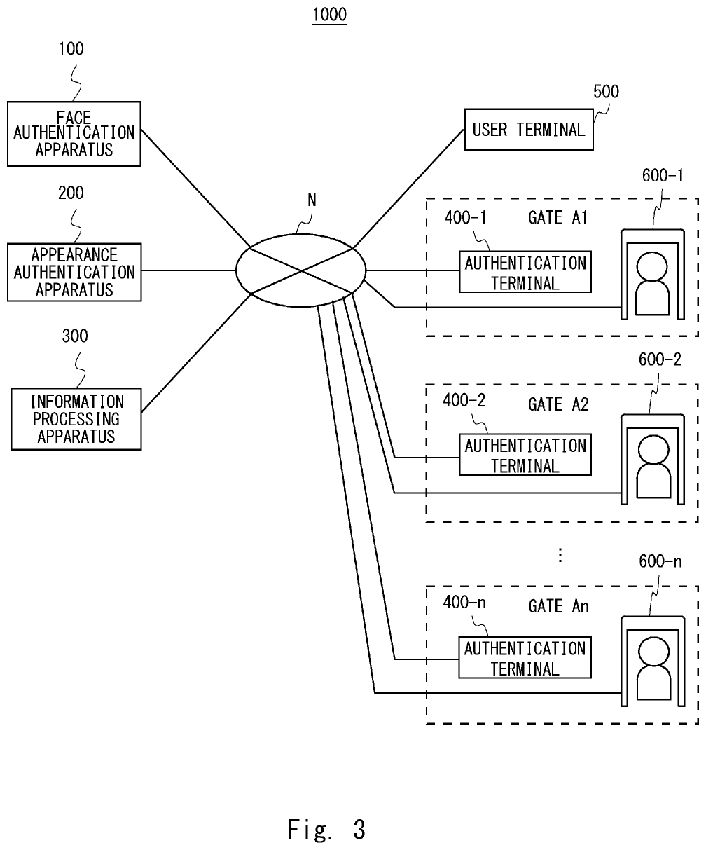

Next, a second example embodiment of the present disclosure will be described. FIG. 3 is a block diagram illustrating an overall configuration of an information processing system 1000 according to the second example embodiment. The information processing system 1000 is a computer system that permits or restricts passage of a user U who is an authentication target person through the gate by multi-factor authentication using image recognition. The information processing system 1000 includes a face authentication apparatus 100, an appearance authentication apparatus 200, an information processing apparatus 300, authentication terminals 400-1 to 400-n (n is a natural number of 1 or more), a user terminal 500, and gate driving apparatuses 600-1 to 600-n. The apparatuses and the terminals are connected to one another via a network N. Here, the network N is a wired or wireless communication line.

Each of the authentication terminals 400-1 to 400-n is installed near gates A1, A2, . . . , and An in such a way as to be able to image at least the face of the user U who is about to pass through the gate. The gate is an entrance/exit gate. The gate may function as, for example, a ticket gate of a station, an entrance/exit gate of a theme park, or an entrance/exit gate of an event venue. Some of the gates A1, A2, . . . , and An may function as a ticket gate of a station, and some may function as an entrance gate of a theme park. In a case where the gates function as ticket gates of stations, the gates may be installed at different stations or may be installed at the same station. Note that the authentication terminals 400-1 to 400-n are preferably installed in such a way that at least the face of the user U can be imaged through a walk-through process. Each of the gate driving apparatuses 600-1 to 600-n controls opening and closing of the gates A1, A2, . . . , and An. Alternatively, each of the gate driving apparatuses 600-1 to 600-n outputs an indication to permit or restrict passage of the user U through the gates A1, A2, . . . , and An. Hereinafter, the authentication terminals 400-1, 400-2, . . . 400-n may be simply referred to as the authentication terminal 400 when being referred to without distinction. The gate driving apparatuses 600-1, 600-2, . . . 600-n may be simply referred to as the gate driving apparatus 600 when being referred to without distinction.

The user U who is a registration target person performs registration for a use of a service in advance by using the user terminal 500 and registers his/her face information. In addition, each user U registers appearance information in advance, or the appearance information is automatically registered. As described above, the appearance information is motion information indicating a motion of the user U or clothing information indicating clothing of the user U. For example, in a case where the appearance information is the motion information, the user U makes a predetermined motion when entering the gate A1. Then, in a case where personal authentication by image recognition is performed and the personal authentication has succeeded, the user U can pass through the gate A1. In addition, the user U makes a predetermined motion when exiting through the gate A2. Then, in a case where personal authentication by image recognition is performed and the personal authentication has succeeded, the user U can pass through the gate A2. Note that the entry and exit of the user U by the personal authentication is recorded, whereby the user U may automatically pay a transportation fare or pay an entrance fee without presenting a magnetic card, an IC card, or a bar code.

Here, the face authentication apparatus 100 is an information processing apparatus that stores face feature information of a plurality of persons. In response to a face authentication request received from the outside, the face authentication apparatus 100 collates a face image or face feature information included in the request with face feature information of each user, and transmits, as a response, the collation result (face authentication result) to a request source.

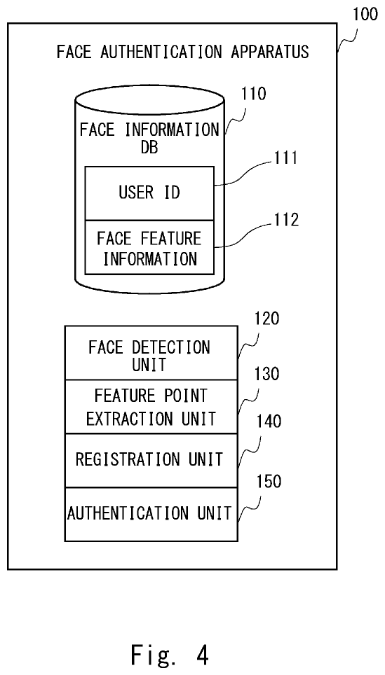

FIG. 4 is a block diagram illustrating a configuration of the face authentication apparatus 100 according to the second example embodiment. The face authentication apparatus 100 includes a face information database (DB) 110, a face detection unit 120, a feature point extraction unit 130, a registration unit 140, and an authentication unit 150. The face information DB 110 stores a user ID 111 and face feature information 112 of the user ID in association with each other. The face feature information 112 is a set of feature points extracted from the face image, and is an example of the face information. Note that the face authentication apparatus 100 may delete the face feature information 112 in the face feature DB 110 in response to a request from a user whose face feature information 112 is registered. Alternatively, the face authentication apparatus 100 may delete the face feature information 112 after a lapse of a certain period from the registration of the face feature information 112.

The face detection unit 120 detects a face region included in a registration image for registering the face information, and outputs the face region to the feature point extraction unit 130. The feature point extraction unit 130 extracts a feature point from the face region detected by the face detection unit 120, and supplies the face feature information to the registration unit 140. In addition, the feature point extraction unit 130 extracts a feature point included in the face image received from the information processing apparatus 300, and supplies the face feature information to the authentication unit 150.

The registration unit 140 newly issues the user ID 111 when registering the face feature information. The registration unit 140 registers the issued user ID 111 and the face feature information 112 extracted from the registration image in the face information DB 110 in association with each other. The authentication unit 150 performs face authentication using the face feature information 112. Specifically, the authentication unit 150 collates the face feature information extracted from the face image with the face feature information 112 in the face information DB 110. The authentication unit 150 transmits, as a response, whether or not the pieces of face feature information match each other to the information processing apparatus 300. Whether or not the pieces of face feature information match each other corresponds to the success or failure of the authentication. A case where the pieces of face feature information match each other means a case where the degree of matching is equal to or higher than a predetermined value.

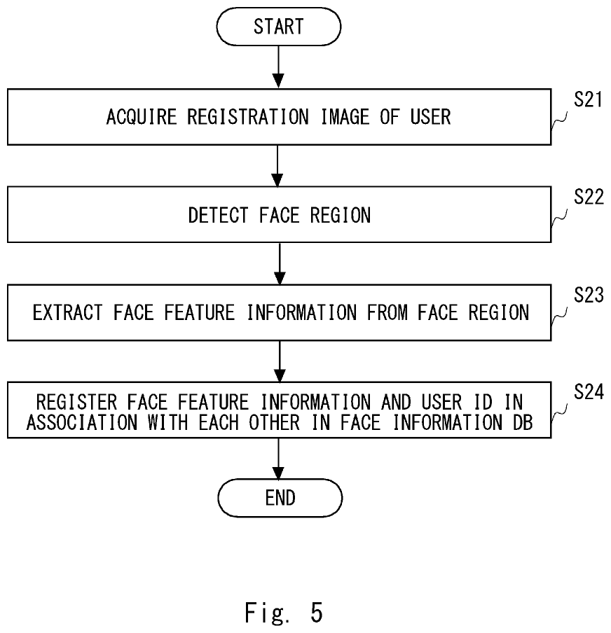

FIG. 5 is a flowchart illustrating a flow of face information registration processing according to the second example embodiment. First, the face authentication apparatus 100 acquires a registration image of the user U included in a face information registration request (S21). For example, the face authentication apparatus 100 receives the face information registration request from the user terminal 500 via the network N. Note that the face information registration request source is not limited thereto, and may be the information processing apparatus 300 that has received a use registration request from the user terminal 500. Next, the face detection unit 120 detects a face region included in the registration image (S22). Next, the feature point extraction unit 130 extracts a feature point from the face region detected in step S22 and supplies face feature information to the registration unit 140 (S23). Finally, the registration unit 140 issues the user ID 111, and registers the user ID 111 and the face feature information 112 in the face information DB 110 in association with each other (S24). Note that the face authentication apparatus 100 may receive the face feature information 112 from the information registration request source and register the face feature information 112 in the face information DB 110 in association with the user ID 111.

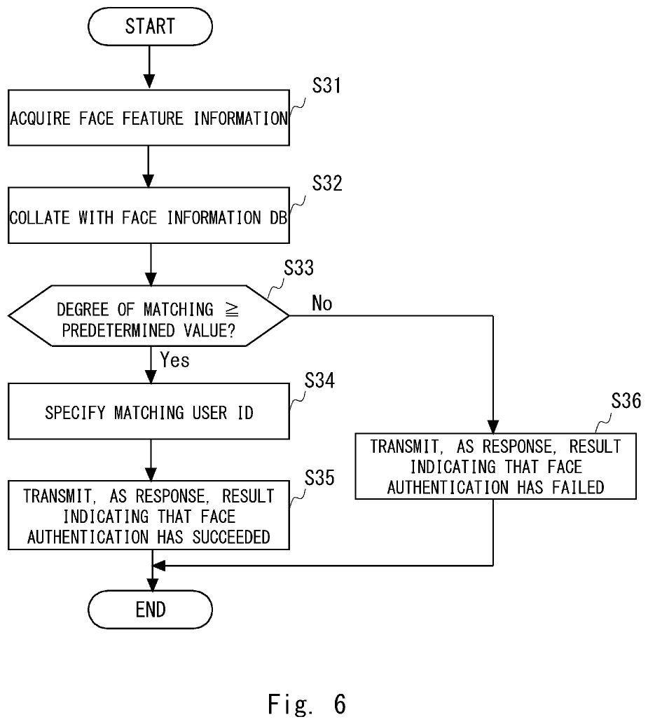

FIG. 6 is a flowchart illustrating a flow of face authentication processing performed by the face authentication apparatus 100 according to the second example embodiment. First, the feature point extraction unit 130 acquires face feature information for authentication (S31). For example, the face authentication apparatus 100 receives a face authentication request from the information processing apparatus 300 via the network N, and extracts the face feature information from a face image included in the face authentication request as in steps S21 to S23. Alternatively, the face authentication apparatus 100 may receive the face feature information from the information processing apparatus 300. Next, the authentication unit 150 collates the acquired face feature information with the face feature information 112 in the face information DB 110 (S32). In a case where the pieces of face feature information match each other, that is, the degree of matching between the pieces of face feature information is equal to or higher than a predetermined value (Yes in S33), the authentication unit 150 specifies the user ID 111 of the user whose face feature information matches (S34). Then, the authentication unit 150 transmits, as a response, a result indicating that the face authentication has succeeded and the specified user ID 111 to the information processing apparatus 300 (S35) At this time, in a case where there is a plurality of user IDs 111 of which the degree of matching between the pieces of face feature information is equal to or higher than a predetermined value, the authentication unit 150 includes, in the face authentication result, information indicating that the face authentication has succeeded and the plurality of user IDs 111 and transmits, as a response, the face authentication result to the information processing apparatus 300. The face authentication result may include information specifying the detected face region, for example, position information of the face region in the captured image. In a case where there is no matching face feature information (No in S33), the authentication unit 150 transmits, as a response, a result indicating that the face authentication has failed to the information processing apparatus 300 (S36).

In step S32, the authentication unit 150 does not need to attempt collation with all pieces of face feature information 112 in the face information DB 110. For example, the authentication unit 150 may preferentially attempt collation with face feature information registered in a period from a date of reception of the face authentication request to a date several days before the date of reception. As a result, a collation speed can be increased. It is sufficient if collation with all pieces of remaining face feature information is performed in a case where the preferential collation has failed.

Returning to FIG. 3, the description will be continued. The appearance authentication apparatus 200 is an information processing apparatus that stores appearance feature information of each appearance (each motion and each clothing). In response to an appearance authentication request received from the outside, the appearance authentication apparatus 200 collates a person image or appearance feature information included in the request, with stored appearance feature information, and transmits, as a response, the collation result (appearance authentication result) to a request source.

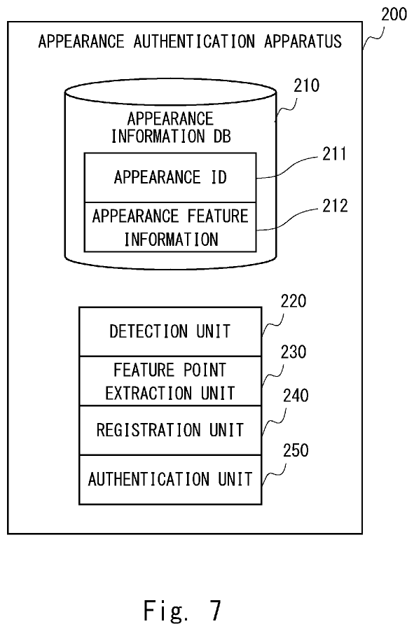

FIG. 7 is a block diagram illustrating a configuration of the appearance authentication apparatus 200 according to the second example embodiment. The appearance authentication apparatus 200 includes an appearance information DB 210, a detection unit 220, a feature point extraction unit 230, a registration unit 240, and an authentication unit 250. The appearance information DB 210 stores an appearance ID 211 and appearance feature information 212 of the appearance ID in association with each other. The appearance ID 211 is information for identifying an appearance of an authentication target. The appearance feature information 212 is a set of feature points extracted from a person image having an appearance corresponding to the appearance ID. The appearance ID 211 and the appearance feature information 212 may be referred to as appearance information.

The detection unit 220 detects a person region included in a sample image for registering the appearance information and a captured image acquired from the information processing apparatus 300, and supplies the person region to the feature point extraction unit 230. The feature point extraction unit 230 extracts a feature point from the person region detected by the detection unit 220, and supplies the appearance feature information to the registration unit 240. Furthermore, the feature point extraction unit 230 extracts a feature point included in the captured image received from the information processing apparatus 300, and supplies the appearance feature information to the authentication unit 250.

The registration unit 240 newly issues the appearance ID 211 when registering the face feature information. The registration unit 240 registers the issued appearance ID 211 and the appearance feature information 212 extracted from the sample image in the appearance information DB 210 in association with each other. The authentication unit 250 performs appearance authentication using the appearance feature information 212. Specifically, the authentication unit 250 acquires the appearance ID registered by the user U as an authentication target from the information processing apparatus 300, and collates the appearance feature information 212 stored in the appearance information DB 210 in association with the acquired appearance ID with the appearance feature information extracted from the captured image. The authentication unit 250 transmits, as a response, whether or not the pieces of appearance feature information match each other to the information processing apparatus 300. Whether or not the pieces of appearance feature information match each other corresponds to the success or failure of the authentication. A case where the pieces of appearance feature information match each other means a case where the degree of matching is equal to or higher than a predetermined value.

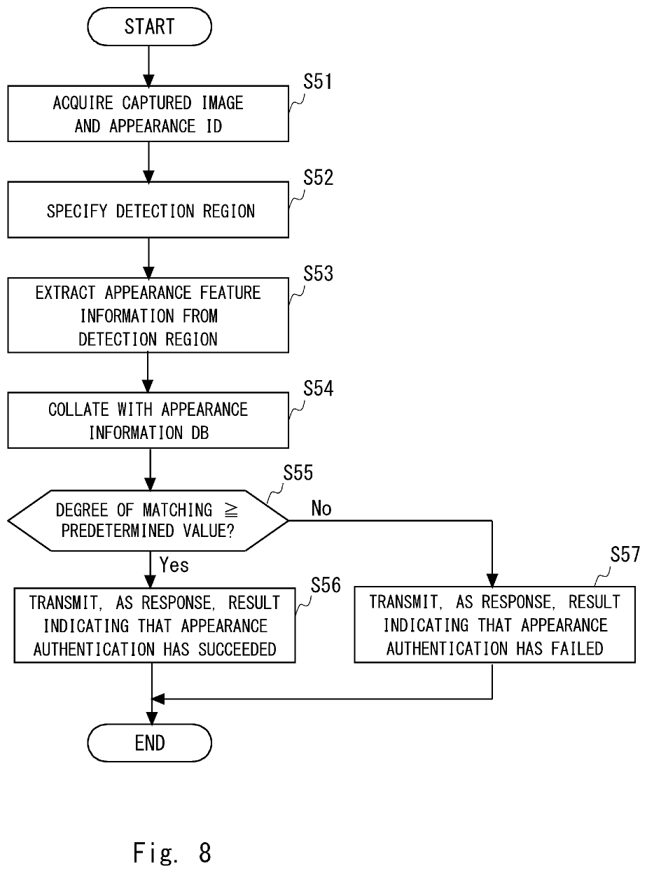

FIG. 8 is a flowchart illustrating a flow of appearance authentication processing according to the second example embodiment. First, the detection unit 220 acquires an appearance authentication request from the information processing apparatus 300 via the network N (S51). The appearance authentication request includes a captured image obtained by imaging the user U and an appearance ID registered as an authentication target by the user U who has succeeded in face authentication. In addition, the appearance authentication request may include information for specifying a face region of the user U who has succeeded in face authentication. Then, the detection unit 220 specifies, as a detection region, a person region included in the captured image (S52). For example, the detection unit 220 may specify a predetermined region of the person region as the detection region according to the acquired appearance ID. Furthermore, in a case where the appearance authentication request includes information for specifying the face region of the user U, the detection unit 220 may specify, as the detection region, a region corresponding to the face region of the user U, for example, a region within a predetermined distance (a predetermined number of pixels) from the face region. As a result, even in a case where a plurality of persons appears in the captured image, an appearance of a person who has succeeded in face authentication can be identified, so that it is possible to avoid false recognition. Then, the feature point extraction unit 230 extracts appearance feature information from the detection region (S53). Alternatively, the appearance authentication apparatus 200 may receive the appearance feature information from the information processing apparatus 300, and in this case, the processing of S51 to 53 is omitted. Next, the authentication unit 250 collates the acquired appearance feature information with the appearance feature information 212 associated with the acquired appearance ID in the appearance information DB 210 (S54). In a case where the pieces of appearance feature information match each other, that is, in a case where the degree of matching between the pieces of appearance feature information is equal to or higher than a predetermined value (Yes in S55), the authentication unit 250 transmits, as a response, a result indicating that the appearance authentication has succeeded to the information processing apparatus 300 (S56). At this time, the authentication unit 250 may transmit the appearance ID and the user ID to the information processing apparatus 300 in addition to the result. On the other hand, in a case where the pieces of appearance feature information do not match each other (No in S55), the authentication unit 250 transmits, as a response, a result indicating that the appearance authentication has failed to the information processing apparatus 300 (S57).

Returning to FIG. 3, the description will be continued. Each of the authentication terminals 400-1, 400-2, . . . , and 400-n is an information terminal including a camera and a display device.

The authentication terminal 400 captures an authentication image used for personal authentication of the user U. For example, the authentication terminal 400 sets a captured image obtained by imaging the user U at each installed gate as the authentication image. The authentication terminal 400 transmits a personal authentication request including the authentication image to the information processing apparatus 300 via the network N. At this time, the authentication terminal 400 may include, in the personal authentication request, a gate ID for identifying the gate where the authentication terminal 400 is installed. The authentication terminal 400 may include an imaging time in the personal authentication request. Note that the authentication terminal 400 may receive personal authentication results from the information processing apparatus 300 via the network N, and may display these pieces of information on a screen as necessary.

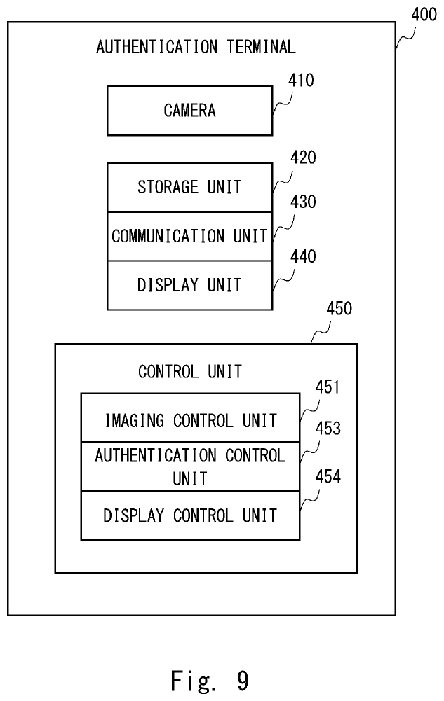

Next, the authentication terminal 400 will be described in detail. FIG. 9 is a block diagram illustrating a configuration of the authentication terminal 400 according to the second example embodiment. The authentication terminal 400 includes a camera 410, a storage unit 420, a communication unit 430, a display unit 440, and a control unit 450.

The camera 410 is an imaging device that performs imaging under the control of the control unit 450. The storage unit 420 is a storage device that stores a program for implementing each function of the authentication terminal 400. The communication unit 430 is a communication interface with the network N. The display unit 440 is a display device. The display unit 440 may be integrated with an input unit (not illustrated). As an example, the display unit 440 is a touch panel. The control unit 450 controls hardware included in the authentication terminal 400. The control unit 450 includes an imaging control unit 451, an authentication control unit 453, and a display control unit 454. Note that the display unit 440 and the display control unit 454 are not necessarily provided.

The imaging control unit 451 controls the camera 410 to capture the authentication image of the user U. The authentication image is an image including at least the face region of the user. In addition, the imaging control unit 451 supplies the authentication image to the authentication control unit 453.

The authentication control unit 453 transmits a personal authentication request including the authentication image to the information processing apparatus 300 via the network N, and receives the personal authentication result. Then, the authentication control unit 453 may supply the personal authentication result to the display control unit 454. The display control unit 454 may display a display content corresponding to the personal authentication result on the display unit 440.

Returning to FIG. 3, the description will be continued. The user terminal 500 is an information terminal used by the user U. The user terminal 500 is a mobile phone terminal, a smartphone, a tablet terminal, a personal computer (PC) on which a camera is mounted or to which a camera is connected, or the like, for example. The user terminal 500 is associated with the user ID of the user U. That is, the user terminal 500 is an information terminal that can be specified by the user ID in the information processing apparatus 300. For example, the user terminal 500 is a terminal into which the user U has logged by using the user ID thereof.

The user terminal 500 transmits a service use registration request to the information processing apparatus 300 via the network N. In addition, the user terminal 500 transmits a registration image to be used for face authentication of the user U to the face authentication apparatus 100 and makes a face information registration request. Note that the user terminal 500 may transmit face feature information extracted from the registration image to the face authentication apparatus 100 to make the face information registration request. The user terminal 500 may transmit the registration image and the face feature information to the face authentication apparatus 100 via the information processing apparatus 300. Furthermore, the user terminal 500 transmits attribute information of the user U and appearance information for registration to the information processing apparatus 300 via the network N at the time of service use registration or the like.

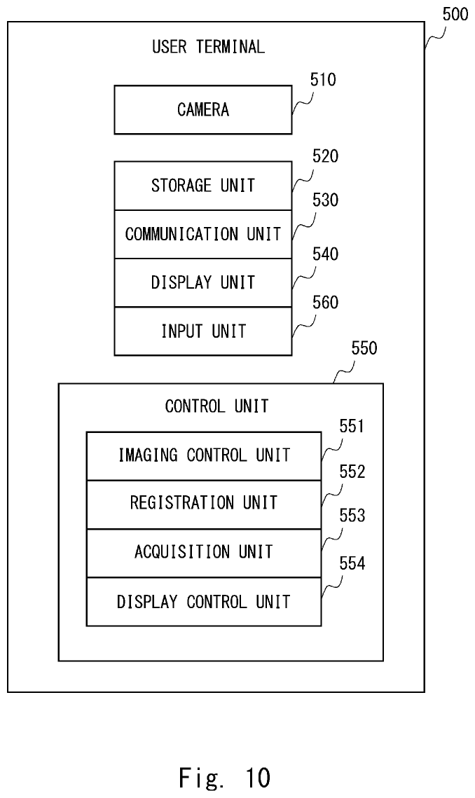

Next, the user terminal 500 will be described in detail. FIG. 10 is a block diagram illustrating a configuration of the user terminal 500 according to the second example embodiment. The user terminal 500 includes a camera 510, a storage unit 520, a communication unit 530, a display unit 540, a control unit 550, and an input unit 560.

The camera 510 is an imaging device that performs imaging under the control of the control unit 550. The storage unit 520 is a storage device that stores a program for implementing each function of the user terminal 500. The communication unit 530 is a communication interface with the network N. The display unit 540 is a display device. The input unit 560 is an input device that receives an input. The display unit 540 and the input unit 560 may be integrated with each other. As an example, the display unit 540 and the input unit 560 are implemented by a touch panel. The control unit 550 controls hardware included in the user terminal 500. The control unit 550 includes an imaging control unit 551, a registration unit 552, an acquisition unit 553, and a display control unit 554.

The imaging control unit 551 controls the camera 510 to capture the registration image of the user U. The imaging control unit 551 outputs the registration image to the registration unit 552.

The registration unit 552 transmits the face information registration request including the registration image to the face authentication apparatus 100 via the network N. Note that the registration unit 552 may transmit the face information registration request to the information processing apparatus 300 via the network N. In addition, the registration unit 552 transmits the service use registration request to the information processing apparatus 300 via the network N. Note that the registration unit 552 may transmit user attribute information received by the input unit 560 to the information processing apparatus 300 via the network N at the time of use registration. The user attribute information may be included in the use registration request.

The acquisition unit 553 acquires one or a plurality of pieces of appearance information (appearance IDs) set for the user U from the information processing apparatus 300 via the network N, and outputs the appearance information to the display control unit 554. The display control unit 554 displays the appearance information on the display unit 540. Note that, in a case where the acquisition unit 553 has acquired a plurality of pieces of appearance information from the information processing apparatus 300, the display control unit 554 displays the plurality of pieces of appearance information on the display unit 540 in such a way that the user U can select the plurality of pieces of appearance information. In this case, the registration unit 552 transmits an appearance ID selected by the user U and received by the input unit 560 from the user U to the information processing apparatus 300 via the network N.

Returning to FIG. 3, the description will be continued. The information processing apparatus 300 is an information processing apparatus that performs personal authentication using a captured image of the user U at the gate A1 or the like and permits or restricts passage of the user U through the gate. The information processing apparatus 300 may be redundant in a plurality of servers, and each functional block may be implemented by a plurality of computers.

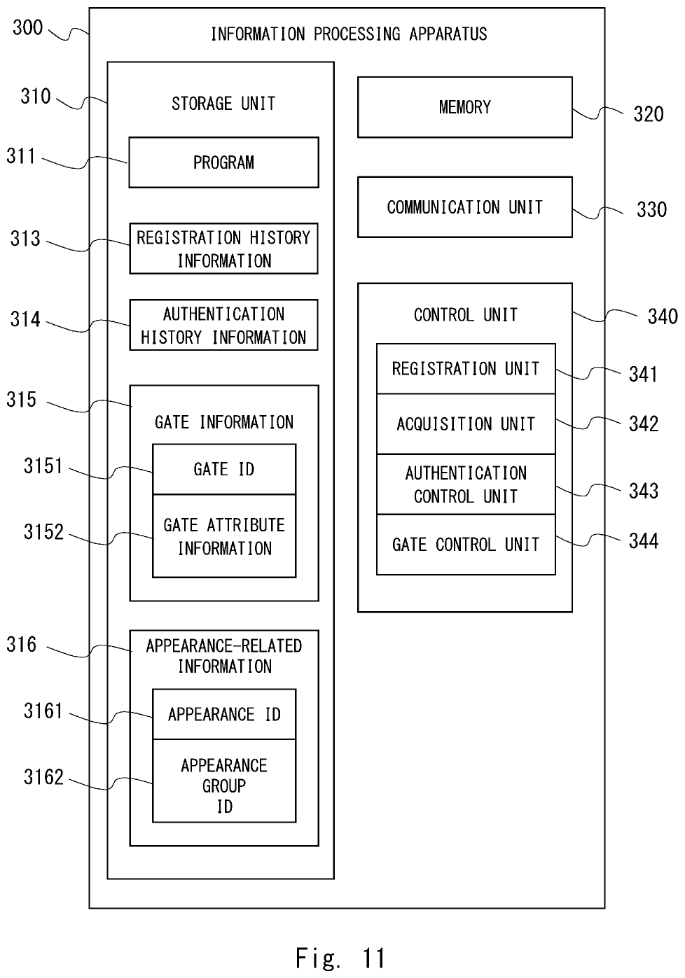

Next, the information processing apparatus 300 will be described in detail. FIG. 11 is a block diagram illustrating a configuration of the information processing apparatus 300 according to the second example embodiment. The information processing apparatus 300 includes a storage unit 310, a memory 320, a communication unit 330, and a control unit 340. The storage unit 310 is a storage device such as a hard disk or a flash memory. The storage unit 310 stores a program 311, registration history information 313, authentication history information 314, gate information 315, and appearance-related information 316. The program 311 is a computer program in which processing of the information processing method according to the second example embodiment is implemented.

The registration history information 313 is history information of registration of user attribute information and appearance information (appearance ID).

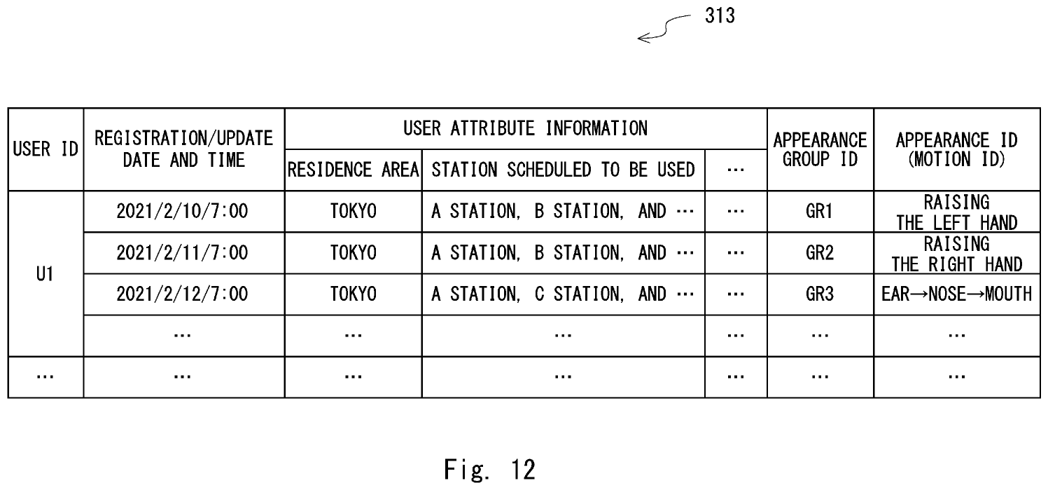

Here, FIG. 12 is a diagram illustrating an example of a data structure of the registration history information 313 according to the second example embodiment. As illustrated in FIG. 12, for example, the registration history information 313 is information in which a user ID, a registration or update date and time, user attribute information, an appearance group ID, and an appearance ID for registration are associated with each other. The user ID is information for identifying the user U, and is a user ID sent when the face information is registered in the face authentication apparatus 100. The user attribute information may include at least one of a residence area of the user U, a near station, a station scheduled to be used, or a railroad line scheduled to be used. Further, the user attribute information may include a use purpose. As an example, the use purpose may be a use for a railway/a use for a theme park/a use for an event venue, or a use for commutation ticket/daily pass ticket/single-use ticket. Note that the user attribute information may include a name, an address, a contact, and personal payment information such as credit card information of the user U. The appearance group ID is an ID for identifying an appearance group, and is also referred to as the appearance information. The appearance group includes a plurality of appearance IDs, and is also referred to as an appearance information group. The appearance ID is an appearance ID for registration selected by the user U among appearance IDs included in an appearance group to which the appearance ID belongs. In a case where the type of the appearance is a motion, the appearance ID is also called a motion ID, and may be, for example, “raising the left hand”, “raising the right hand”, or “sequentially touching the ear, the nose, and the mouth”. Furthermore, in a case where the type of the appearance is clothing, the appearance ID is also called a clothing ID, and may be, for example, “wearing red clothes”, “carrying a blue baggage”, “wearing a hat”, or “wearing a red wristband on the right hand”. The appearance ID for registration, that is, the appearance information for registration, is associated with the face feature information 112 (face information for registration) in the face information DB 110 of the face authentication apparatus 100 via the user ID. Note that the registration history information 313 in FIG. 12 is configured in such a way that each user U is associated with one piece of appearance information for registration, but the user U may be associated with different appearance information for each use scene. For example, the user U may set different appearance information for registration for each station scheduled to be used. Furthermore, the user U may set different appearance information for registration for each use purpose.

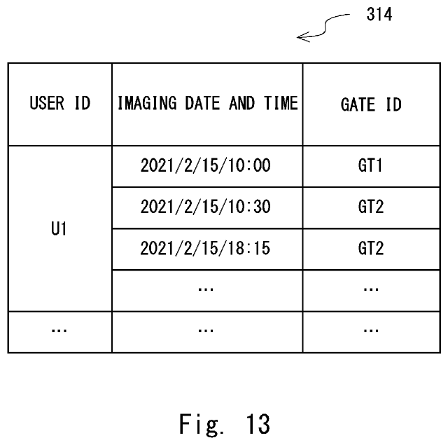

The authentication history information 314 is history information of personal authentication at the gate. FIG. 13 is a diagram illustrating an example of a data structure of the authentication history information 314 according to the second example embodiment. As illustrated in FIG. 13, for example, the authentication history information 314 is information in which a user ID, an imaging date and time, and a gate ID are associated with each other. The user ID is a user ID that has succeeded in face authentication in the personal authentication. The imaging date and time may be a date and time when the personal authentication is performed. The gate ID is information for identifying a gate through which the user U is scheduled to pass at the time of the personal authentication.

Returning to FIG. 11, the description will be continued. The gate information 315 is information in which a gate ID 3151 and gate attribute information 3152 are associated with each other. The gate attribute information 3152 is attribute information of the gate, and may include a facility type in which the gate is installed and point information in which the gate is installed. For example, in a case where the gate functions as a ticket gate of a station, the facility type may be “railway” and the point information may be “Shinjuku station”. Furthermore, in a case where the gate functions as an entrance/exit gate of a theme park, the facility type may be “theme park”, and the point information may be “main gate”. Note that the point information may include position information indicated by longitude and latitude.

The appearance-related information 316 is information in which an appearance group ID 3162 and appearance IDs 3161 are associated with each other. The appearance group ID 3162 includes a plurality of appearance IDs 3161. Therefore, the appearance group ID 3162 is associated with a plurality of appearance IDs 3161.

The memory 320 is a volatile storage device such as a random access memory (RAM), and is a storage area for temporarily holding information during the operation of the control unit 340. The communication unit 330 is a communication interface with the network N.

The control unit 340 is a processor that controls each component of the information processing apparatus 300, that is, a control apparatus. The control unit 340 reads the program 311 from the storage unit 310 into the memory 320 and executes the program 311. As a result, the control unit 340 implements the functions of a registration unit 341, an acquisition unit 342, an authentication control unit 343, and a gate control unit 344.

The registration unit 341 is an example of the registration unit 11 described above. In a case where the face information of the user U is registered by the face authentication apparatus 100 at the time of service use registration and a notification of the user ID is made, the registration unit 341 registers the user ID in the storage unit 310 as the user ID of the registration history information 313. In a case where the user attribute information is acquired from the user terminal 500, the registration unit 341 registers the acquired user attribute information in the storage unit 310 as the user attribute information of the registration history information 313 in association with the user ID.

Then, the registration unit 341 sets an appearance group, that is, a plurality of appearance IDs serving as options of the appearance information for registration, for the registered user U. Setting the appearance group may be selecting one appearance group from among predetermined appearance groups. Setting the appearance group may include setting a plurality of appearance IDs as options, configuring the appearance group to include the plurality of appearance IDs, and issuing an appearance group ID. In a case where an appearance group is newly configured, the registration unit 341 registers the appearance group ID 3162 and the appearance ID 3161 as the appearance-related information 316. Then, the registration unit 341 outputs the appearance ID included in the appearance group to the user terminal 500 via the network N. At this time, for each user U, the registration unit 341 displays each appearance ID included in the appearance group on the display unit 540 of the user terminal 500 in such a way that the user U can select the appearance ID. Then, in a case where the appearance ID selected by the user U is received from the user terminal 500, the registration unit 341 registers the set appearance group ID and the appearance ID selected by the user U as the registration history information 313.

Here, the registration unit 341 may set the appearance group for each user U based on the user attribute information registered in the registration history information 313. For example, in a case where a station where the number of entering persons is equal to or more than a predetermined number is included in stations scheduled to be used, the registration unit 341 may set the appearance group in such a way as to include an appearance ID indicating a complex appearance. The complex appearance may be a motion in which a plurality of single motions is combined, such as “sequentially touching the ear, the nose, and the mouth”, or clothing in which a plurality of items is combined, such as “wearing red clothes and a yellow wristband”. Alternatively, in this case, the registration unit 341 may configure the appearance group in such a way that the number of appearance IDs included as options is larger by a predetermined number than that in case where a station where the number of entering persons is equal to or more than the predetermined number is not included in the stations scheduled to be used. Furthermore, for example, the registration unit 341 may specify a gate scheduled to be used by the user U based on a residence area, and in a case where the predicted number of users of the specified gates is equal to or more than a predetermined number, the appearance group may be set to include an appearance ID indicating a complex appearance, similarly to the above. Furthermore, as described above, an appearance group including a larger number of appearance IDs included as options than that in a case where the predicted number of users is less than the predetermined number may be configured. Furthermore, in a case where the use purpose is included in the user attribute information, the registration unit 341 may specify the gate scheduled to be used by the user U based on the use purpose, and set the appearance group by a method similar to that for the residence area as described above. The gate scheduled to be used by the user U is a gate having gate attribute information according to the use purpose. As an example, in a case where the use purpose is “the use for a railway”, the registration unit 341 configures an appearance group in such a way that the number of appearance IDs included as options is larger by a predetermined number than that in a case of “the use for a theme park”. Furthermore, as an example, in a case where the use purpose is “the use for an event venue”, the registration unit 341 may predict the number of persons scheduled to enter based on an event type of the event venue, and set the appearance group according to the number of persons scheduled to enter by a method similar to that described above. Note that, in a case where a scheduled date and time when the user U uses the event venue is registered as the user attribute information, the appearance group may be set according to the scheduled date and time. As an example, in a case where the scheduled date and time is a congested time zone in a holiday, the registration unit 341 may configure the appearance group in such a way that an appearance ID indicating a complex appearance is included or the number of appearance IDs included as options is larger than that in other time zones or weekdays. For example, the registration unit 341 may configure and set the appearance group and register the appearance ID as described above in response to registration of the user attribute information at a timing of event reservation. As described above, even at a gate used by a large number of users, it is possible to avoid false recognition by complicating the appearance or increasing the variation. Therefore, authentication accuracy can be improved.

Furthermore, in a case where a similarity between face information for registration of each user U and face information for registration of another user U is equal to or higher than a predetermined threshold, the registration unit 341 may set the appearance ID for registration of the user U to be different from an appearance ID for registration of the similar user U. Furthermore, in this case, the registration unit 341 may set the appearance group of the user U to a group different from that of the similar user U, and cause the user U to select an appearance ID from the appearance group to make the appearance ID for registration different. That is, the registration unit 341 sets the appearance IDs presented as options to the user U to be different from appearance IDs presented to the similar user U, and causes the user U to select an appearance ID from the set appearance IDs. The similarity may be calculated based on the face feature information 112 stored in the face information DB 110 of the face authentication apparatus 100. The calculation of the similarity may be performed by the face authentication apparatus 100, and the registration unit 341 may acquire a user ID having a similarity equal to or higher than the predetermined threshold from the face authentication apparatus 100 via the network N. As described above, in a case where face structures are similar, a plurality of users U may be specified by face authentication. However, if the authentication target appearance is clearly different, it is possible to more clearly distinguish which of the specified users U is the authentication target person by the appearance authentication. Therefore, false authentication can be avoided, and authentication accuracy can be improved.

Then, in a case where a predetermined update condition is satisfied, the registration unit 341 updates the appearance information for registration, that is, the appearance ID of the registration history information 313. Updating the appearance information for registration means that the registration unit 341 changes the appearance group of the registration history information 313 for the user U who satisfies the predetermined update condition, and updates the appearance ID for registration to an appearance ID selected from the changed appearance group. Here, changing the appearance group may include changing the appearance group of the registration history information 313 to an appearance group including an appearance ID indicating a complex appearance for the user U who satisfies the predetermined update condition. Changing the appearance group may include changing the appearance group of the registration history information 313 to an appearance group including a larger number of appearance IDs included as options than that of the set appearance group for the user U who satisfies the predetermined update condition. Note that updating the appearance information for registration may include outputting the appearance ID included in the changed appearance group to the user terminal 500 and receiving selection of the changed appearance ID from the user U. Then, updating the appearance information for registration may include adding a new record to the registration history information 313 and recording the changed appearance ID selected by the user U in the added record. Here, the predetermined update condition may be passage of the user U through the gate. That is, the registration unit 341 updates the appearance ID of the registration history information 313 in response to the entry or exit of the user U passing through the gate. For example, in a case where the type of the appearance is a motion, a motion for authentication is changed for each entry/exit. As a result, even in a case where the motion for authentication is known to another person at the time of passing through the gate, since a motion at the time of passing through the gate next is different from the motion at the time of passing through the gate immediately before, the security level of the personal authentication can be improved. Note that the update of the appearance information for registration is not limited to every passage through the gate, and may be performed in a case where the user passes through the gate a predetermined number of times by using the same appearance information at the time of authentication (for example, the same motion may be made at the time of authentication).

The predetermined update condition may be that a predetermined period has elapsed from a registration date and time or a previous update date and time. That is, the registration unit 341 may update the appearance information for registration for each user U in a case where the predetermined period has elapsed from the registration date and time or the previous update date and time. The predetermined period may be, for example, one day, one week, or one month. Note that the registration unit 341 may update the appearance information for registration for the user U at a predetermined time every day. Furthermore, in a case where a request for updating the user attribute information is received from the user terminal 500, the registration unit 341 may update the user attribute information of the registration history information 313 and update the appearance information for registration based on the updated user attribute information. For example, the registration unit 341 may update the appearance information for registration in response to a change in type of the gate scheduled to be used by the user U by updating the user attribute information. Examples of a case where the type of the gate is changed include a case where the use purpose is changed from a theme park to a railway and a case where a departing or arrival station is different from usual. As a result, the security level of the personal authentication is improved. Furthermore, for example, in a case where the predicted number of users of the gate scheduled to be used by the user U is changed by a predetermined number or more due to the update of the user attribute information, the registration unit 341 may update the appearance information for registration of the user U. As an example, a case where the predicted number of users of the gate scheduled to be used is changed by the predetermined number or more includes a case where the number of users increases more than usual due to a large event held near the gate. As a result, it is possible to avoid false authentication while improving the security level of the personal authentication.

In addition, the predetermined update condition may be that a failure rate of the personal authentication is equal to or higher than a predetermined threshold. That is, in a case where the failure rate of the user U is equal to or higher than the predetermined threshold, the registration unit 341 may update the appearance information for registration of the user U. Note that the registration unit 341 may update the appearance information for registration of the user U in a case where a failure rate of the face authentication is equal to or higher than the predetermined threshold, instead of the failure rate of the personal authentication. In this case, there is a possibility that the face authentication fails because the face of the user U is similar to that of another user U. Therefore, the registration unit 341 may specify a similar user whose face information for registration is similar to that of the user U, and set (update) the appearance ID for registration of the user U to be different from that of the similar user. The similar user is specified in a similar manner to that described above. In addition, the setting (update) of the appearance ID for registration is performed in a similar manner to that described above, and includes changing the appearance group. Accordingly, the authentication accuracy can be improved.

Here, an example of a method of calculating the failure rate of the user U will be described. First, the information processing apparatus 300 specifies the user ID by a predetermined method in response to the failure of the personal authentication. For example, in a case where the personal authentication has failed, the user U presents an IC card, a barcode, or the like, and causes the authentication terminal 400 to read the user ID. The authentication terminal 400 transmits the acquired user ID and gate ID to the information processing apparatus 300 via the network N. Next, the information processing apparatus 300 records, in the authentication history information 314, a result indicating that the personal authentication has failed in association with the user ID. Note that the information processing apparatus 300 may record a failure reason indicating which authentication has failed in the authentication history information 314 based on the face authentication result and the appearance authentication result. Then, the information processing apparatus 300 calculates the failure rate of the personal authentication or the failure rate of each authentication method for each user U by using the authentication history information 314, and records the calculated failure rate in the storage unit 310 in association with the user ID.

The acquisition unit 342 is an example of the acquisition unit 12 described above. The acquisition unit 342 acquires a personal authentication request including captured image data through the communication unit 330 from the authentication terminal 400 via the network N. The captured image data may be a captured image of a still image or a moving image including a plurality of captured images (frames). In particular, in a case where the appearance information for registration is motion information, the captured image data may be a moving image. The acquisition unit 342 supplies the acquired captured image data to the authentication control unit 343.

The authentication control unit 343 is an example of the authentication control unit 13 described above. The authentication control unit 343 controls face authentication for the face region of the user U included in the captured image of the captured image data. That is, the authentication control unit 343 controls face authentication for the face region of the user U included in the captured image of the captured image data captured at each gate. That is, the authentication control unit 343 causes the face authentication apparatus 100 to perform face authentication for the captured image acquired from the authentication terminal 400. For example, the authentication control unit 343 transmits a face authentication request including the acquired captured image data, the gate ID, and the imaging date and time to the face authentication apparatus 100 via the network N. In a case where the captured image data is a moving image, the authentication control unit 343 may include some captured images (frames) included in the captured image data in the face authentication request, or may include all the frames in the face authentication request. At this time, the face feature information for authentication is generated for each of the plurality of frames. The authentication control unit 343 may detect the face region of the user U from the captured image included in the captured image data and include the image of the face region in the face authentication request. The authentication control unit 343 may extract face feature information from the face region and include the face feature information in the face authentication request. Then, the authentication control unit 343 receives the face authentication result from the face authentication apparatus 100.

Then, in a case where the face authentication has succeeded, the authentication control unit 343 refers to the registration history information 313 and acquires the appearance ID recorded in the latest record of the user ID included in the face authentication result. Then, the authentication control unit 343 controls appearance authentication for the detection region of the user U included in the captured image of the captured image data. For example, an appearance authentication request including the captured image data and the appearance ID is transmitted to the appearance authentication apparatus 200 via the network N. Also here, in a case where the captured image data is a moving image, the authentication control unit 343 may include some frames included in the captured image data in the appearance authentication request, or may include all the frames in the appearance authentication request. In addition, the authentication control unit 343 may include, in the appearance authentication request, a frame for which the face authentication has failed among the frames included in the captured image data. In a case where the appearance ID indicates a motion, particularly, a plurality of motions, the authentication control unit 343 includes a plurality of frames in the appearance authentication request. At this time, the appearance information for authentication is generated for each of the plurality of frames. Furthermore, in a case where a face region to be subjected to the face authentication can be specified, the authentication control unit 343 may include information for specifying the face region in the appearance authentication request. In this case, the authentication control unit 343 may detect a detection region corresponding to the appearance ID of the user U from the captured image based on the face region, and include the image of the detection region in the appearance authentication request. Then, the authentication control unit 343 receives the appearance authentication result from the appearance authentication apparatus 200.

The authentication control unit 343 performs the personal authentication based on the face authentication result and the appearance authentication result. For example, in a case where the face authentication has succeeded and the appearance authentication has succeeded, the authentication control unit 343 determines that the personal authentication has succeeded. The authentication control unit 343 determines that the personal authentication has failed in cases other than the above cases. The authentication control unit 343 supplies the personal authentication result to the gate control unit 344.

The gate control unit 344 is an example of the gate control unit 14 described above. In a case where the personal authentication result indicates that the personal authentication has succeeded, the gate control unit 344 transmits a control signal for opening the gate to the gate driving apparatus 600 that controls the gate at the point where the user U is imaged. On the other hand, in a case where the personal authentication result indicates that the personal authentication has failed, the gate control unit 344 transmits a control signal for closing the gate to the gate driving apparatus that controls the gate at the point where the user U is imaged. Note that the control signal transmitted from the gate control unit 344 to the gate driving apparatus 600 may be a control signal for causing the gate driving apparatus 600 to output a result indicating that the personal authentication has succeeded or unsuccessful, instead of the control signal for opening or closing the gate.

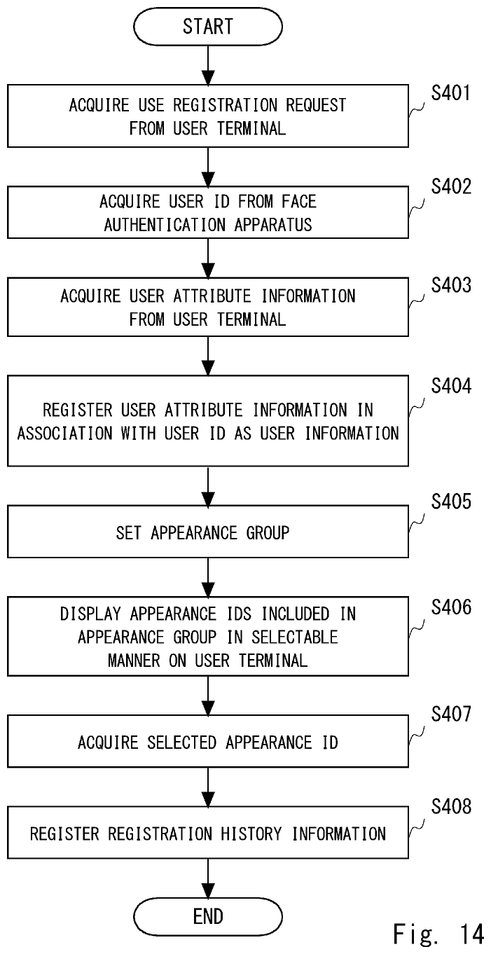

FIG. 14 is a flowchart illustrating a flow of registration processing according to the second example embodiment. First, the registration unit 341 of the information processing apparatus 300 receives a service use registration request from the user terminal 500 via the network N (S401). Note that, at this time, in a case where a captured image is received in addition to the use registration request, the registration unit 341 requests the face authentication apparatus 100 to register face information in the face information DB 110 via the network N.

Subsequently, the registration unit 341 acquires a user ID from the face authentication apparatus 100 via the network N (S402). Then, the registration unit 341 acquires attribute information of the user U from the user terminal 500 that is the request source via the network N (S403). Then, the registration unit 341 registers the attribute information of the user U as the user attribute information of the registration history information 313 in association with the user ID (S404). Subsequently, the registration unit 341 sets an appearance group based on the user attribute information (S405). Then, the registration unit 341 refers to the appearance-related information 316 and acquires appearance IDs included in the appearance group. Subsequently, the registration unit 341 transmits a plurality of appearance IDs included in the appearance group to the user terminal 500, and causes the user terminal 500 to display the appearance IDs in a selectable manner (S406). In a case where the user U selects one appearance ID from among the plurality of appearance IDs displayed on the display unit 540 of the user terminal 500, the registration unit 341 acquires the selected appearance ID from the user terminal 500 (S407). Then, the registration unit 341 registers a registration date and time, an appearance group ID, and the selected appearance ID in the registration history information 313 in association with the user ID (S408).

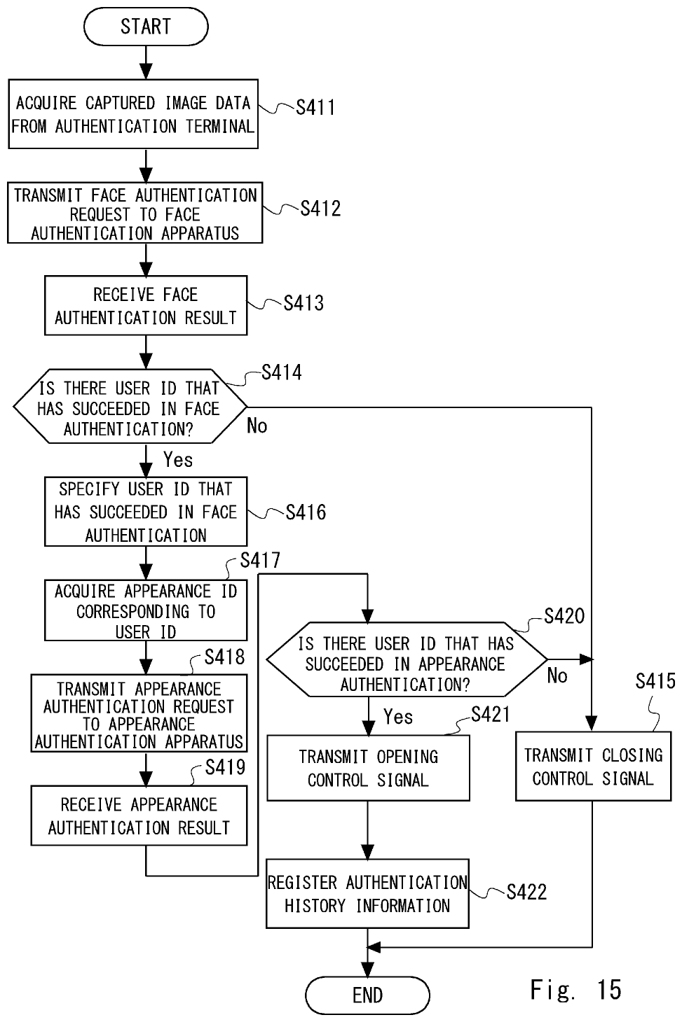

FIG. 15 is a flowchart illustrating a flow of personal authentication processing according to the second example embodiment. First, the authentication control unit 343 acquires captured image data from the authentication terminal 400 via the network N (S411). Next, the authentication control unit 343 transmits a face authentication request to the face authentication apparatus 100 via the network N (S412). At this time, the authentication control unit 343 includes, in the face authentication request, at least one of the captured image data acquired in step S411, some captured images included in the captured image data, a face region extracted from the captured image, or face feature information extracted from the face region. Then, the authentication control unit 343 receives a face authentication result from the face authentication apparatus 100 via the network N (S413). In a case where the face authentication has succeeded, the face authentication result includes information indicating that the face authentication has succeeded, a user ID, and information for specifying the face region, and in a case where the face authentication has failed, the face authentication result includes information indicating that the face authentication has failed. Note that the face authentication result may include a plurality of user IDs, and in this case, the face authentication result includes information for specifying the face region corresponding to each user ID.

The authentication control unit 343 determines whether or not there is a user ID that has succeeded in face authentication (S414). In a case where there is no user ID that has succeeded in face authentication (No in S414), the authentication control unit 343 determines that the personal authentication has failed, and transmits a control signal for closing the gate to the gate driving apparatus 600 corresponding to the authentication terminal 400 that is an imaging source via the network N (S415). Then, the authentication control unit 343 ends the processing.

On the other hand, in a case where it is determined that there is a user ID that has succeeded in face authentication (Yes in S414), the authentication control unit 343 specifies the user ID that has succeeded in face authentication (S416). Specifically, the authentication control unit 343 extracts the user ID included in the face authentication result. Hereinafter, in a case where there is a plurality of user IDs included in the face authentication result, steps S417 to 419 are executed for each user ID.

In step S417, the authentication control unit 343 acquires the appearance ID included in the latest registration history information 313 for the extracted user ID. Then, in step S418, the authentication control unit 343 transmits an appearance authentication request to the appearance authentication apparatus 200 via the network N (S418). At this time, the authentication control unit 343 includes, in the appearance authentication request, at least one of the captured image data acquired in step S411, some captured images included in the captured image data, a detection region extracted from the captured image, or appearance feature information extracted from the detection region. In addition, the authentication control unit 343 may include information for specifying the face region in the appearance authentication request. Then, the authentication control unit 343 receives the appearance authentication result from the appearance authentication apparatus 200 via the network N (S419). The appearance authentication result includes information indicating that the appearance authentication has succeeded or unsuccessful. The appearance authentication result may include the user ID in a case where the appearance authentication has succeeded.

The authentication control unit 343 determines whether or not there is a user ID that has succeeded in appearance authentication (S420). In a case where there is no user ID that has succeeded in appearance authentication (No in S420), the authentication control unit 343 determines that the personal authentication has failed, and transmits a control signal for closing the gate to the gate driving apparatus 600 corresponding to the authentication terminal 400 that is an imaging source via the network N (S415). Then, the authentication control unit 343 ends the processing. On the other hand, in a case where there is a user ID that has succeeded in appearance authentication (Yes in S420), the authentication control unit 343 determines that the personal authentication has succeeded, and transmits a control signal for opening the gate to the gate driving apparatus 600 corresponding to the authentication terminal 400 that is the imaging source (S421). Then, in step S422, the authentication control unit 343 registers the user ID, the imaging date and time, the gate ID, the authentication result, and the failure reason as the authentication history information 314.

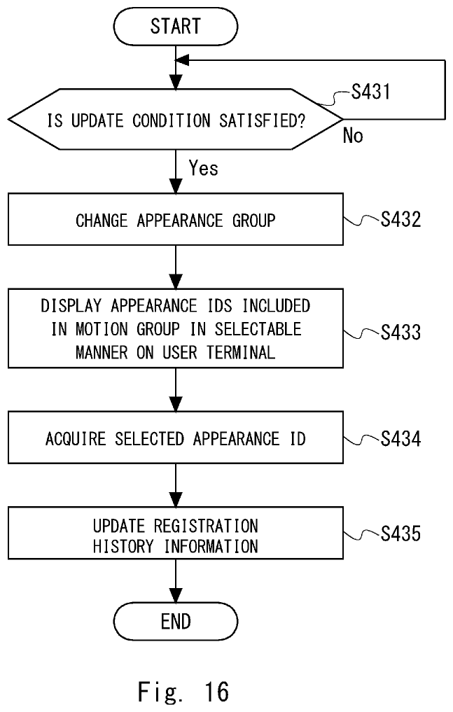

FIG. 16 is a flowchart illustrating a flow of appearance information update processing according to the second example embodiment. In a case where the above-described predetermined update condition is satisfied (Yes in S431), the registration unit 341 executes the appearance information update processing illustrated in steps S432 to 435. First, the registration unit 341 changes the appearance group for the user U whose appearance information is to be updated (S432). Then, the registration unit 341 refers to the appearance-related information 316 and acquires appearance IDs included in the changed appearance group. Next, the registration unit 341 transmits the appearance IDs included in the appearance group to the user terminal 500, and causes the user terminal 500 to display the appearance IDs in a selectable manner (S433). In a case where the user U selects one appearance ID from among the appearance IDs displayed on the display unit 540 of the user terminal 500, the registration unit 341 acquires the selected appearance ID from the user terminal 500 (S434). Then, the registration unit 341 updates the appearance group ID and the appearance ID of the registration history information 313 to the changed appearance group ID and the newly selected appearance ID (S435).

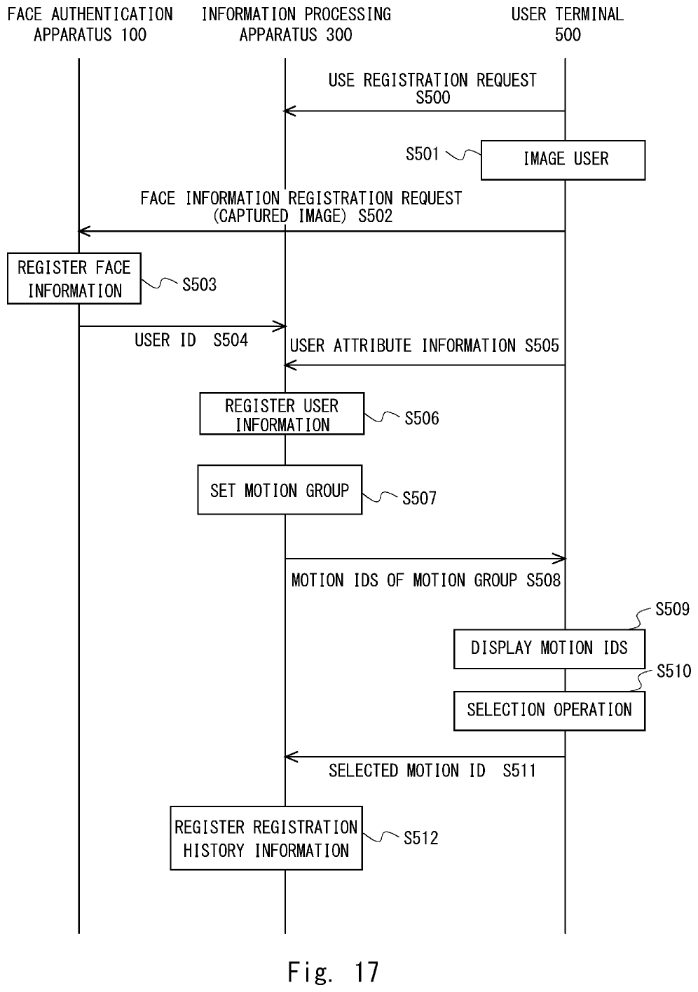

Next, an example of processing in a case where the type of the appearance is a motion will be described with reference to FIGS. 17 to 24. In FIGS. 17 to 24, an appearance group is referred to as a motion group, an appearance ID is referred to as a motion ID, and appearance authentication is referred to as motion authentication.

FIG. 17 is a sequence diagram illustrating a flow of registration processing according to the second example embodiment.

First, the user terminal 500 transmits a service use registration request to the information processing apparatus 300 (S500). Further, the user terminal 500 images the user U (S501), and transmits a face information registration request including the captured image to the face authentication apparatus 100 via the network N (S502). Then, the face authentication apparatus 100 registers face information (face feature information) of the user U based on the captured image included in the received face information registration request (S503). Then, the face authentication apparatus 100 notifies the information processing apparatus 300 of the user ID via the network N (S504). Furthermore, the user terminal 500 transmits the user attribute information to the information processing apparatus 300 via the network N (S505). The information processing apparatus 300 registers the transmitted user ID and user attribute information in the registration history information 313 in association with each other (S506). Then, the information processing apparatus 300 sets a motion group for the user U (S507). The information processing apparatus 300 transmits a plurality of motion IDs included in the motion group to the user terminal 500 via the network N (S508). The user terminal 500 that has received the motion IDs displays the motion IDs (S509).

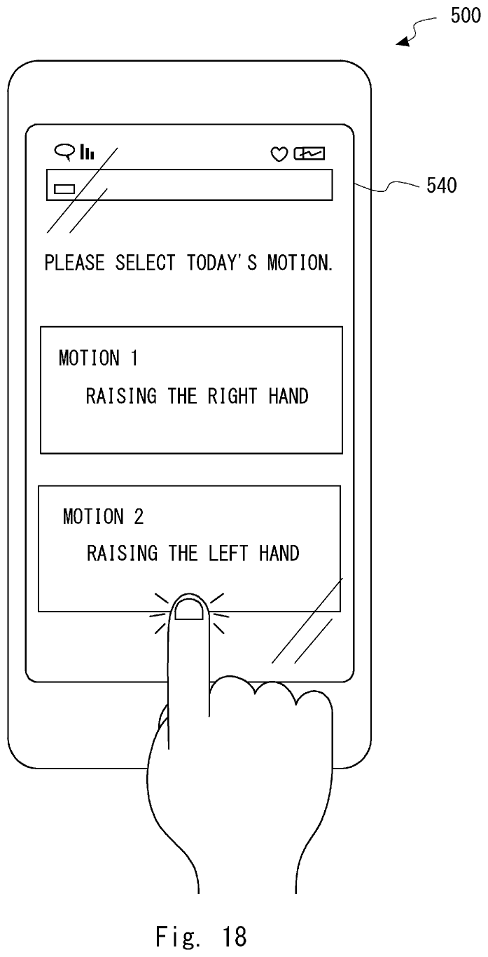

Here, FIG. 18 is a view illustrating an example of display on the user terminal 500 according to the second example embodiment. Motions 1 and 2 are displayed in a selectable manner together with a message “Please select today's motion” on the display unit 540 of the user terminal 500. The motion 1 is a motion ID of “raising the right hand”, and the motion 2 is a motion ID of “raising the left hand”. In FIG. 18, the user U selects the motion 2.

Returning to FIG. 17, the description will be continued. The user terminal 500 receives an operation of selecting a motion ID from the user U (S510), and transmits the selected motion ID to the information processing apparatus 300 via the network N (S511). Then, the information processing apparatus 300 registers, as the registration history information 313, the user ID, the registration date and time, the motion group, and the motion ID in association with one another (S512).

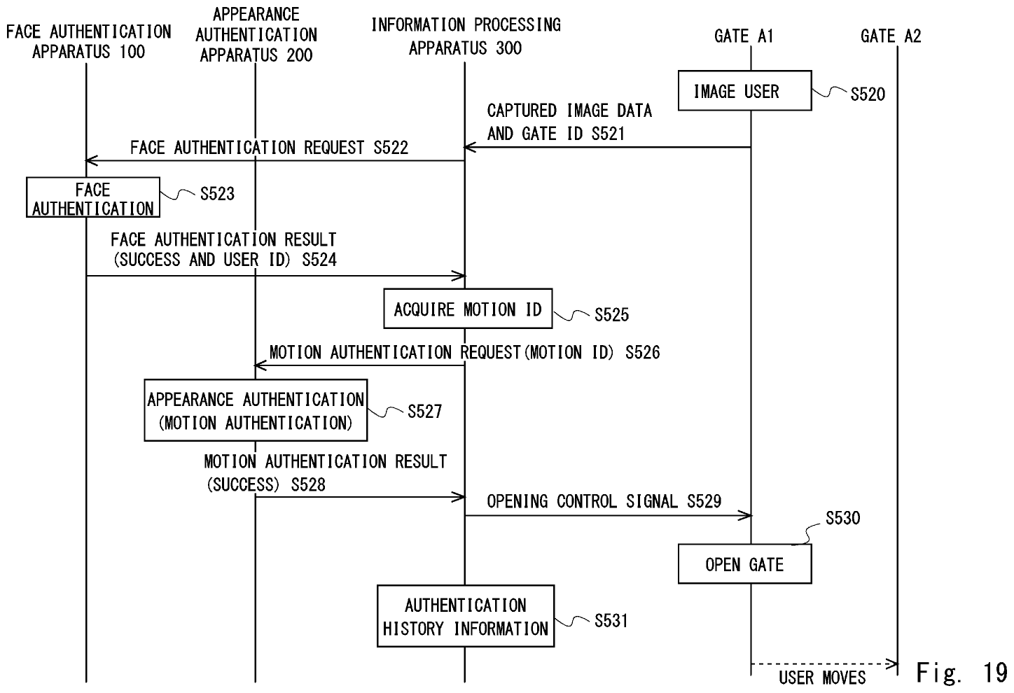

FIG. 19 is a sequence diagram illustrating a flow of the personal authentication processing according to the second example embodiment. First, at the gate A1, the authentication terminal 400-1 images the user U (S520), and transmits the captured image data and the gate ID to the information processing apparatus 300 via the network N (S521). The information processing apparatus 300 transmits a face authentication request for the face region of the user U in the received captured image to the face authentication apparatus 100 via the network N (S522). Then, the face authentication apparatus 100 performs face authentication for the face region of the user U in the captured image included in the received face authentication request (S523). Here, it is assumed that there is a user ID that has succeeded in face authentication. The face authentication apparatus 100 transmits the face authentication result including information indicating that the face authentication has succeeded and the user ID to the information processing apparatus 300 via the network N (S524).

The information processing apparatus 300 that has received the face authentication result acquires a motion ID corresponding to the user ID included in the face authentication result from the registration history information 313 (S525). Subsequently, the information processing apparatus 300 transmits a motion authentication request including the motion ID and the captured image data to the appearance authentication apparatus 200 via the network N (S526). Then, the appearance authentication apparatus 200 performs motion authentication for a detection region of the user U in the captured image data included in the received motion authentication request (S527). Here, it is assumed that there is a user ID that has succeeded in motion authentication. The appearance authentication apparatus 200 transmits the motion authentication result including information indicating that the motion authentication has succeeded to the information processing apparatus 300 via the network N (S528). The information processing apparatus 300 that has received the motion authentication result determines that the personal authentication has succeeded, and transmits an opening control signal to the gate driving apparatus 600 that controls the gate A1 (S529). As a result, the gate A1 is opened (S530). In addition, the information processing apparatus 300 registers the authentication history information 314 (S531). Then, the user U passes through (enters) the gate A1 and moves to the gate A2.

Note that the information processing apparatus 300 may determine that the personal authentication has succeeded only in a case where both the face authentication and the motion authentication for the same captured image (frame) are successful. Specifically, in a case where the face feature information for authentication and the motion feature information for authentication are generated based on the same frame included in the captured image data, and both the face authentication and the motion authentication are successful, the information processing apparatus 300 determines that the personal authentication has succeeded.

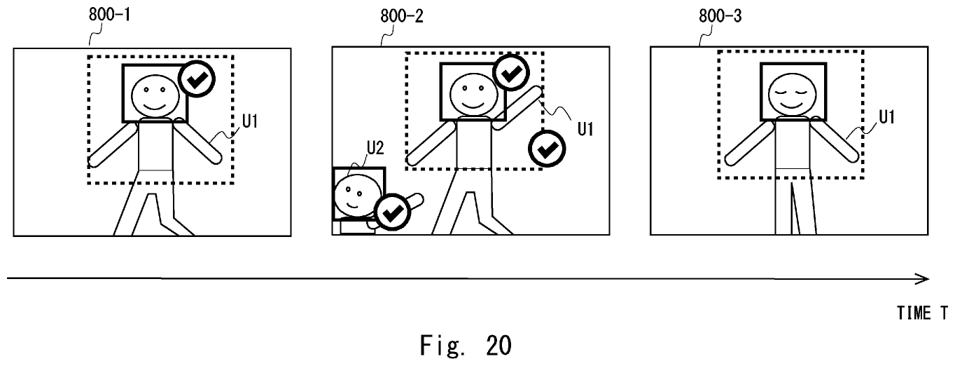

FIG. 20 is a view for describing an example of the personal authentication processing according to the second example embodiment. As illustrated in FIG. 20, captured image data included in a face authentication request includes captured images 800-1 to 800-3 whose imaging timings are different. First, the face authentication apparatus 100 detects a user U1 included in the captured images 800-1 to 800-3 and specifies a user ID of the user U1. Here, it is assumed that the face authentication for the captured images 800-1 and 800-2 has succeeded. Therefore, the information processing apparatus 300 transmits a motion authentication request to the appearance authentication apparatus 200 for the captured images 800-1 and 800-2. The motion authentication request may include, for each of the captured images 800-1 and 800-2, a motion ID for registration of the user U1 specified by the face authentication, and information for specifying a face region of the user U1. Then, the appearance authentication apparatus 200 specifies a detection region in the vicinity of the face region of the user U1 for each of the captured images 800-1 and 800-2, and determines whether or not the detection region corresponds to a predetermined motion ID. Here, it is assumed that the appearance authentication apparatus 200 determines that only the captured image 800-2 corresponds to the predetermined motion ID. In this case, the appearance authentication apparatus 200 transmits the motion authentication result indicating that the motion authentication has succeeded to the information processing apparatus 300. The information processing apparatus 300 that has received the motion authentication result determines that the personal authentication for the user U1 has succeeded. In the captured image 800-2, a face region of a user U2 is detected in addition to the user U1. Therefore, the appearance authentication apparatus 200 also performs motion authentication for the user U2 in the captured image 800-2. However, the detection region cannot be specified for the user U2 in the captured image 800-2, and the motion authentication fails. Note that even in a case where the detection region is specified for the user U2 in the captured image 800-2 and a motion of the user U2 corresponds to the motion ID for registration of the user U1, if the motion does not correspond to a motion ID for registration of the user U2, the appearance authentication apparatus 200 may fail the motion authentication.

As described above, by determining that the personal authentication has succeeded only in a case where both the face authentication and the motion authentication for the same frame are successful, the security level of the personal authentication can be improved, and the personal authentication can be appropriately performed. Since the detection region for the motion authentication is determined based on the face region for which the face authentication has succeeded, false authentication is less likely to occur even in a situation where there is a person around.

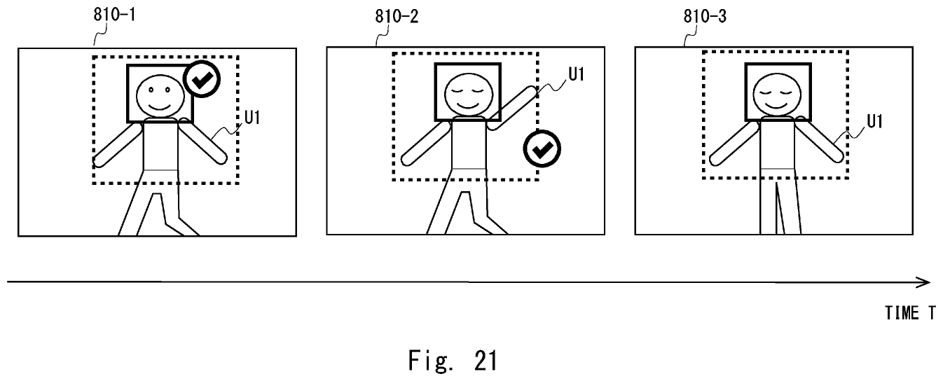

Alternatively, the information processing apparatus 300 may determine that the personal authentication has succeeded even in a case where a frame for which the face authentication has succeeded and a frame for which the motion authentication has succeeded are different in the same captured image data. FIG. 21 is a view for describing an example of the personal authentication processing according to the second example embodiment. As illustrated in FIG. 21, captured image data included in a face authentication request includes captured images 810-1 to 810-3. The face authentication has succeeded for the captured image 810-1, and the face authentication has failed for the captured images 810-2 and 810-3. Here, the information processing apparatus 300 calculates a movement distance based on an imaging interval (frame rate) between the captured image 810-1 and the captured image 810-2, and determines that the user U1 in the captured image 810-1 is the same person as the user U1 in the captured image 810-2. Therefore, the information processing apparatus 300 transmits a motion authentication request to the appearance authentication apparatus 200 also for the captured image 800-2. The motion authentication request may include a motion ID for registration of the user U1 specified by the face authentication for the captured image 810-1 and information for specifying the face region of the user U1 in the captured image 810-2. The appearance authentication apparatus 200 performs the motion authentication for the captured image 800-2, and determines whether or not the detection region corresponds to the motion ID included in the motion authentication request. Here, it is assumed that the appearance authentication apparatus 200 determines that the detection region of the captured image 800-2 corresponds to the motion ID included in the motion authentication request. In this case, the appearance authentication apparatus 200 transmits the motion authentication result indicating that the motion authentication has succeeded to the information processing apparatus 300. As a result, the information processing apparatus 300 determines that the personal authentication has succeeded.

In this manner, the personal authentication can be appropriately performed by determining whether or not the personal authentication has succeeded based on a combination of the face authentication result and the motion authentication result for a plurality of frames in the same captured image data. For example, in a case where the personal authentication is performed through a walk-through process, even when a part of a subject cannot be clearly captured in some frames, the personal authentication can be appropriately performed. The user U who has succeeded in face authentication once is tracked, and the detection region for the motion authentication is determined based on the face region of the user U determined to be the same person. Therefore, false authentication is less likely to occur even in a situation where there is a person around.

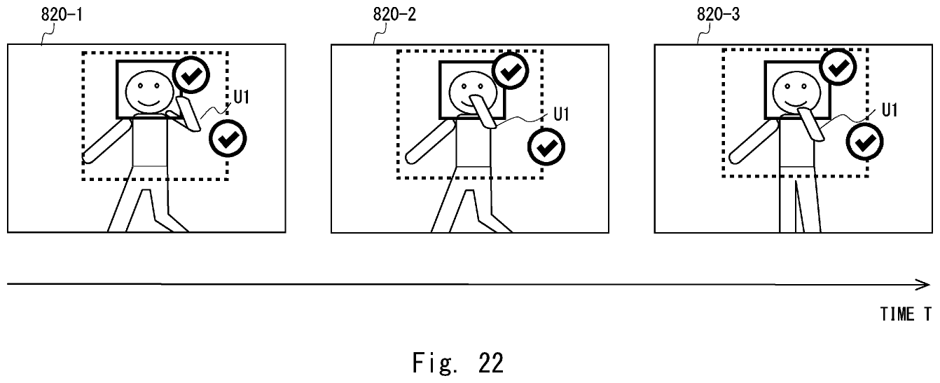

Furthermore, in a case where the motion ID indicates a combination of a plurality of motions (referred to as individual motions), the information processing apparatus 300 may determine that the personal authentication has succeeded when a frame for which the face authentication has succeeded and individual motion authentication has succeeded exists in the captured image data for each individual motion. FIG. 22 is a view for describing an example of the personal authentication processing according to the second example embodiment.

For example, it is assumed that a motion ID for registration of the user U1 indicates a first individual motion→a second individual motion→a third individual motion. As illustrated in FIG. 22, captured image data included in a face authentication request includes captured images 820-1 to 820-3. The captured image 820-1 is a frame (first frame) for which the face authentication has succeeded and authentication of the first individual motion has succeeded. The captured image 820-2 is a frame (second frame) for which the face authentication has succeeded and authentication of the second individual motion has succeeded. The captured image 820-3 is a frame (third frame) for which the face authentication has succeeded and authentication of the third individual motion has succeeded. In a case where the first to third frames are included in the captured image data, the information processing apparatus 300 may determine that the personal authentication has succeeded. Note that, in a case where the order of the individual motions is determined as in this example, the information processing apparatus 300 may determine that the personal authentication has succeeded in a case where the imaging order is the order of the first frame→the second frame→the third frame.

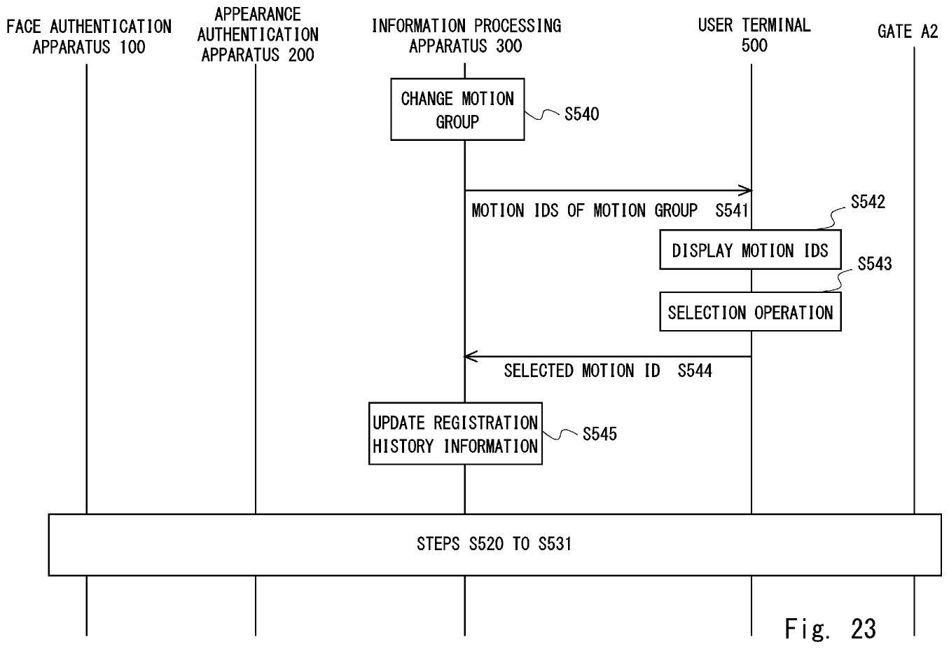

FIG. 23 is a sequence diagram illustrating a flow of update processing according to the second example embodiment. In a case where a predetermined update condition is satisfied, the information processing apparatus 300 changes the motion group for the user U (S540). Then, the information processing apparatus 300 transmits a motion ID included in motion IDs included in the changed motion group to the user terminal 500 via the network N (S541). The user terminal 500 that has received the motion IDs displays the motion IDs (S542).

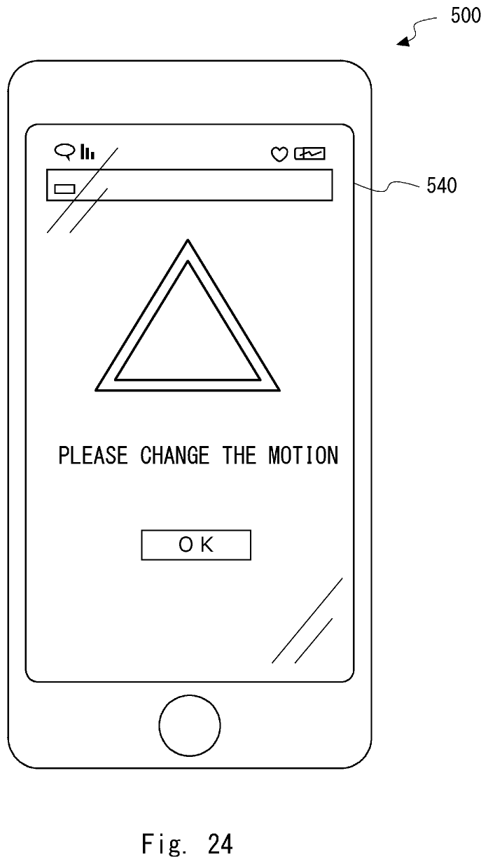

Here, FIG. 24 is a view illustrating an example of display on the user terminal 500 according to the second example embodiment. For example, before the motion IDs are displayed, a message “Please change the motion” may be displayed on the display unit 540 of the user terminal 500 as illustrated in FIG. 24. Thereafter, a screen similar to that in FIG. 18 may be displayed on the display unit 540 of the user terminal 500.

Returning to FIG. 23, the description will be continued. The user terminal 500 receives an operation of selecting a motion ID from the user U (S543), and transmits the selected motion ID to the information processing apparatus 300 via the network N (S544). Then, the information processing apparatus 300 newly registers, as the registration history information 313, information in which the user ID is associated with the update date and time, the motion group, and the motion ID, and updates the registration history information 313 (S545). Then, in a case where the user U moves to the gate A2, processing similar to the processing illustrated in step S520 to S531 of FIG. 19 is executed.

As described above, according to the second example embodiment, the information processing apparatus 300 performs the multi-factor authentication for the face authentication and the appearance authentication using by the image recognition, and updates the appearance information for registration used for the appearance authentication in a case where a predetermined update condition is satisfied. Therefore, it is possible to improve the security level by reducing a risk in a case where personal information called the appearance information is leaked and abused while improving the authentication accuracy by using the multi-factor authentication. This is particularly effective when the personal authentication is performed at a ticket gate of a station or an entrance/exit gate of a theme park where people are around. By changing an update mode for the appearance information according to the type of the update condition, it is possible to perform appropriate personal authentication according to the situation.

### Third Example Embodiment

Next, a third example embodiment of the present disclosure will be described. In the second example embodiment, the information processing apparatus 300 performs the personal authentication based on the face authentication result and one appearance authentication result. That is, the personal authentication is two-factor authentication. However, according to the third example embodiment, an information processing apparatus 300 can perform personal authentication based on a face authentication result and a plurality of appearance authentication results. In the following description, it is assumed that a maximum of two types of appearance authentication can be performed for personal authentication, that is, a maximum of three-factor authentication can be performed. However, the number of types (the number of factors) of the appearance authentication is not limited thereto. The type of the appearance authentication (the type of the factor) is the type of authentication target appearance information, and examples thereof include a motion and clothing.

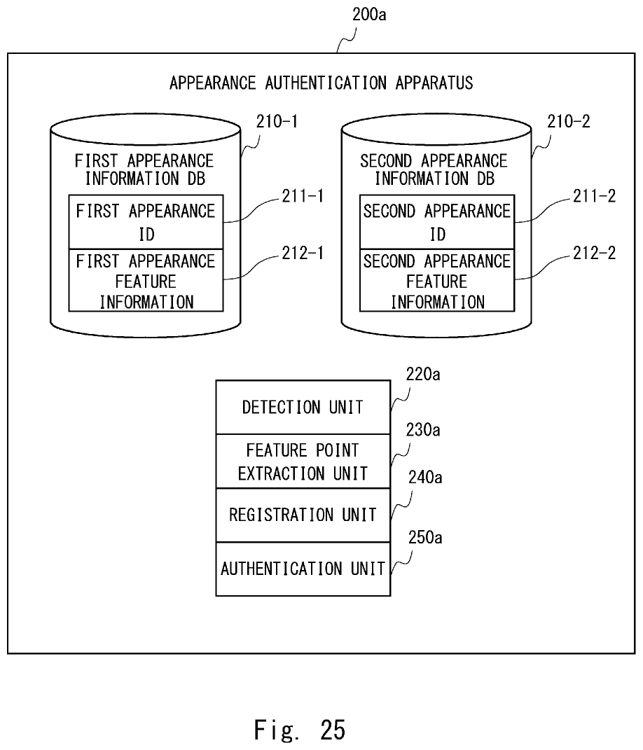

FIG. 25 is a block diagram illustrating a configuration of an appearance authentication apparatus 200a according to the third example embodiment. The appearance authentication apparatus 200a has a configuration and a function basically similar to those of the appearance authentication apparatus 200. However, the appearance authentication apparatus 200a includes a first appearance information DB 210-1 and a second appearance information DB 210-2 instead of the appearance information DB 210. The first appearance information DB 210-1 and the second appearance information DB 210-2 may have a data structure similar to that of the appearance information DB 210, but the factor types are different. For example, the first appearance information DB 210-1 stores motion information, and the second appearance information DB 210-2 stores clothing information. Specifically, the first appearance information DB 210-1 stores, as the motion information, a first appearance ID 211-1 and first appearance feature information 212-1 corresponding thereto. In addition, the second appearance information DB 210-2 stores, as the clothing information, a second appearance ID 211-2 and second appearance feature information 212-2 corresponding thereto.

In addition, the appearance authentication apparatus 200a includes a detection unit 220a, a feature point extraction unit 230a, a registration unit 240a, and an authentication unit 250a. The detection unit 220a, the feature point extraction unit 230a, the registration unit 240a, and the authentication unit 250a basically function similarly to the detection unit 220, the feature point extraction unit 230, the registration unit 240, and the authentication unit 250, respectively. However, the registration unit 240a registers an appearance ID and appearance feature information in the appearance information DB 210 corresponding to the factor type. In addition, in a case where the appearance authentication apparatus 200a receives an appearance authentication request including information indicating the factor type from the information processing apparatus 300, the detection unit 220a, the feature point extraction unit 230a, and the authentication unit 250a execute the above-described various types of processing by using the appearance information DB 210 corresponding to the factor type.

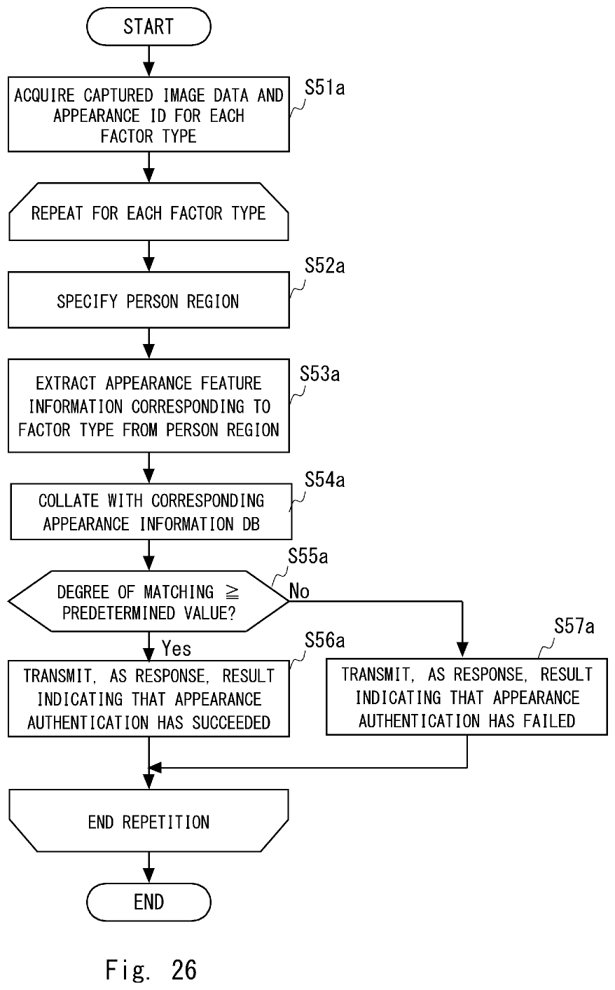

FIG. 26 is a flowchart illustrating a flow of appearance authentication processing according to the third example embodiment. First, the detection unit 220a acquires an appearance authentication request from the information processing apparatus 300 via a network N (S51a). At this time, the appearance authentication request includes captured image data and an appearance ID for registration for each factor type of a user U specified by face authentication. Then, the appearance authentication apparatus 200a repeats processing of steps S52a to S57a corresponding to step S52 to S57 of FIG. 8 for each factor type. Note that, in step S56a, the authentication unit 250a may transmit a result indicating that the appearance authentication has succeeded and the appearance ID to the information processing apparatus 300 in association with a user ID.

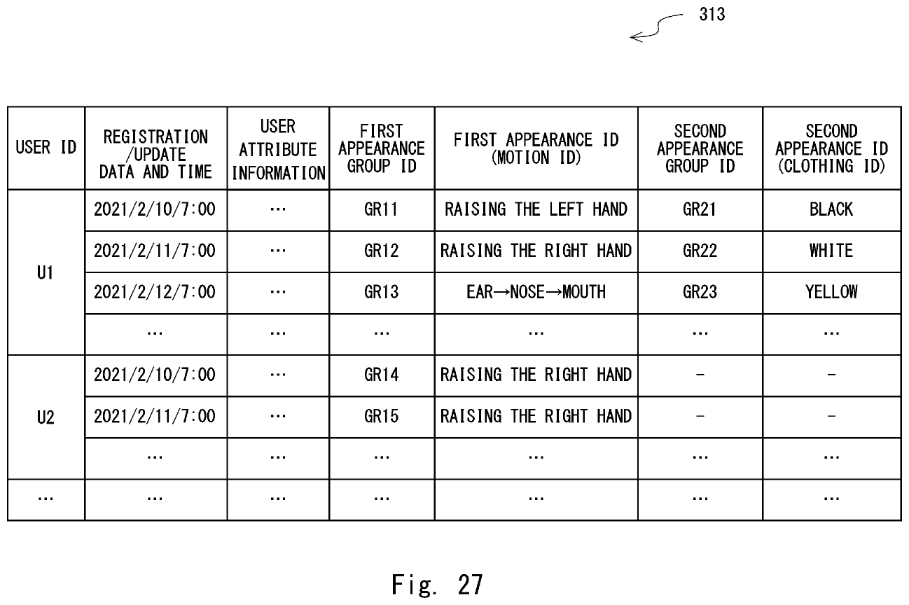

FIG. 27 is a diagram illustrating an example of a data structure of registration history information 313 according to the third example embodiment. In the registration history information 313 of a storage unit 310 of the information processing apparatus 300 according to the third example embodiment, appearance information can be recorded for each factor type. That is, in the registration history information 313, fields of an appearance group ID and an appearance ID are set for each factor type. A registration unit 341 of the information processing apparatus 300 sets the number of factor types, that is, the number of factors and the types thereof for each user U, and records, in the registration history information 313, the appearance group ID and the appearance ID according to the set factor type. For example, the motion information (first appearance information) and the clothing information (second appearance information) are registered as the appearance information for a user U1. Therefore, an authentication control unit 343 performs personal authentication of the user U1 based on a second appearance authentication result in addition to a face authentication result and a first appearance authentication result. On the other hand, only the motion information (first appearance information) is registered as the appearance information for a user U2. Therefore, the authentication control unit 343 performs personal authentication of the user U2 based on the face authentication result and the first appearance authentication result.

Here, in a case where a predetermined factor addition condition is satisfied, the registration unit 341 of the information processing apparatus 300 according to the third example embodiment adds a predetermined number of pieces of appearance information of a factor type different from that of the appearance information for registration already registered for the user U. For example, in a case where the predetermined factor addition condition is satisfied for each user U, the registration unit 341 additionally registers the second appearance information for registration of a factor type different from that of the first appearance information for registration for the user U. The predetermined factor addition condition may be a condition that the predicted number of users of a gate scheduled to be used by the user U is equal to or more than a predetermined number. Alternatively, the predetermined factor addition condition may be a condition that a failure rate of the personal authentication of the user U is equal to or higher than a predetermined threshold. In a case where the predetermined factor addition condition is satisfied, the information processing apparatus 300 may notify a user terminal 500 of the user U that the appearance information is to be additionally registered.

In a case where a predetermined factor reduction condition is satisfied, the registration unit 341 deletes a predetermined number of pieces of appearance information from a plurality of pieces of appearance information for registration registered for the user U. For example, in the case where a predetermined factor reduction condition is satisfied for each user U, the registration unit 341 deletes one of the first appearance information and the second appearance information for registration registered for the user U. The predetermined factor reduction condition may be a condition that the predicted number of users of the gate used by the user U is less than a predetermined number. Alternatively, the predetermined factor reduction condition may be a condition that the failure rate of the personal authentication of the user U is lower than the predetermined threshold. In a case where the predetermined factor reduction condition is satisfied for each user U, the registration unit 341 may delete all the pieces of appearance information for registration registered for the user U. That is, in a case where the user U who satisfies the predetermined factor reduction condition passes through the gate, the appearance authentication may be omitted, and only the face authentication may be required. Therefore, in a case where the predetermined factor reduction condition is satisfied, the information processing apparatus 300 may notify the user terminal 500 of the user U that the appearance authentication is omitted.

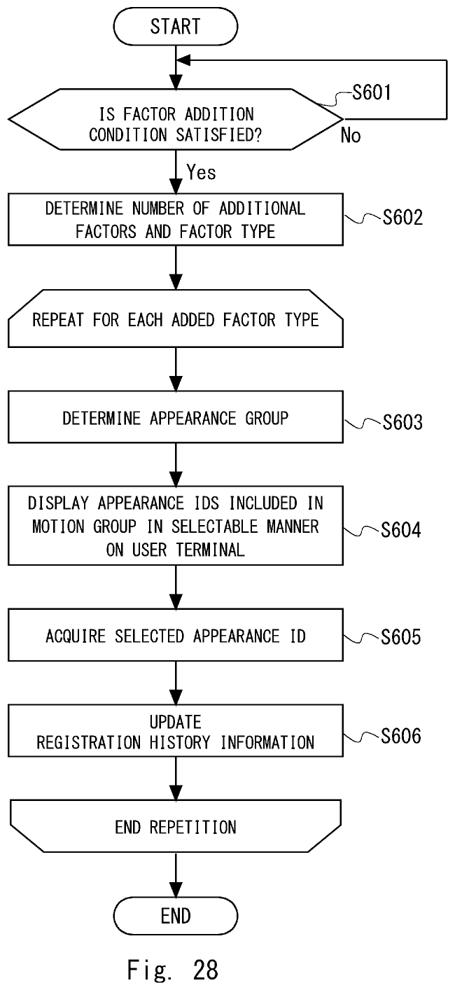

FIG. 28 is a flowchart illustrating a flow of factor addition processing according to the third example embodiment. In a case where the above-described factor addition condition is satisfied (Yes in S601), the registration unit 341 executes processing from step S602. In step S602, the registration unit 341 determines the number of additional factors and the type of the factors to be added. Next, the registration unit 341 repeats processing in steps S603 to S606 for each type of the factor to be added. Since the processing in step S603 to S606 is similar to the processing in steps S432 to S435 of FIG. 16, a description thereof will be omitted.

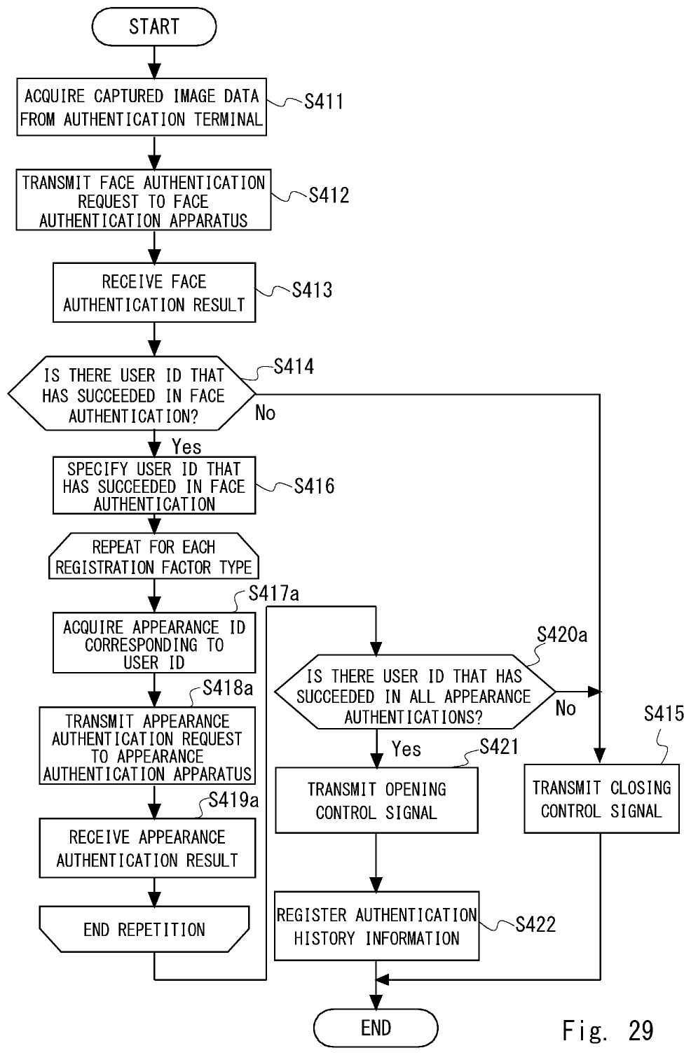

FIG. 29 is a flowchart illustrating a flow of personal authentication processing according to the third example embodiment. Steps in FIG. 29 include steps S417a to S420a instead of step S417 to S420 in FIG. 15.

In response to the specification of the user ID that has succeeded in the face authentication (S416), the authentication control unit 343 refers to the latest registration history information 313 of the user U and repeats the processing in steps S417a to S419a for each factor type of the appearance ID for registration. Steps S417a to S419a correspond to steps S417 to S419. Then, the authentication control unit 343 determines whether or not there is a user ID that has succeeded in appearance authentications corresponding to all factor types for which the appearance ID for registration is registered (S420a). In a case where there is a user ID (Yes in S420a), the authentication control unit 343 proceeds the processing to step S421, and otherwise (No in S420a), the authentication control unit 343 proceeds the processing to step S415. The subsequent steps are similar to those in FIG. 15.

As described above, according to the third example embodiment, in a case where the condition is satisfied, the number of factors for the appearance authentication is changed, so that an appropriate authentication accuracy, authentication speed, and security level can be secured according to the situation.

Note that the present disclosure is not limited to the above example embodiments, and can be appropriately changed without departing from the gist. For example, according to the second and third example embodiment, the registration unit 341 of the information processing apparatus 300 sets an appearance group for the user U at the time of registration or update, and the user U selects appearance information for registration from among a plurality of pieces of appearance information. However, instead, the registration unit 341 may automatically set the appearance information for registration to the user U at the time of registration or update. That is, it is not necessary for the user U to be able to select the appearance information for registration. Then, the information processing apparatus 300 may transmit the automatically set appearance information for registration to the user terminal 500 and cause the display unit 540 of the user terminal 500 to display the appearance information for registration together with a message “Please make this motion”. Alternatively, the registration unit 341 may register or update the appearance information of the user U based on the captured image of the user U captured for registering the appearance information. As an example, a camera is installed at the entrance of the user U, and when the user U goes out, the clothing of the user U is imaged, and the captured image is transmitted to the information processing apparatus 300. The information processing apparatus 300 estimates the clothing information of the user U based on the captured image and registers the clothing information in the registration history information 313.

Furthermore, in a case where the user U approaches an arbitrary gate, the information processing apparatus 300 may notify the user terminal 500 of the appearance information for registration. For example, the information processing apparatus 300 may acquire the position information of the user terminal 500 at predetermined intervals, and determine that the user U approaches an arbitrary gate in a case where a distance between the user terminal 500 and the arbitrary gate is less than a predetermined distance. The position information of the user terminal 500 is, for example, a global positioning system (GPS) information acquired from a GPS receiver. Furthermore, in a case where the distance between the user terminal 500 and the arbitrary gate is less than the predetermined distance, the user terminal 500 may request the information processing apparatus 300 to update the appearance information for registration and acquire the updated appearance information for registration from the information processing apparatus 300. Furthermore, in a case where the user U approaches a gate scheduled to be used or a station or event venue where a gate scheduled to be used is installed, the information processing apparatus 300 may notify the user terminal 500 of the appearance information for registration. For example, the information processing apparatus 300 may determine that the user U approaches a gate scheduled to be used in a case where a distance between the user terminal 500 and the gate scheduled to be used, the station, or the event venue is less than a predetermined distance.

Furthermore, the user U may transmit a registration request or an update request for the appearance information for registration to the information processing apparatus 300 via the user terminal 500. The information processing apparatus 300 registers or updates the appearance information related to the registration request or the update request as the appearance information for registration of the user U in response to the registration request or the update request for the appearance information. Note that, in a case where the appearance information for registration of the user U is registered or updated in response to the registration request or the update request for the appearance information, the information processing apparatus 300 may update the appearance information for registration to different appearance information when another user U having similar or the same appearance information for registration exists. For example, in a case where the appearance information for registration is registered in response to the registration request of the user U, the information processing apparatus 300 determines whether or not there is a user having similar appearance information for registration. Then, in a case where there is a user having similar appearance information for registration or in a case where the number of similar users is equal to or larger than a predetermined number, the information processing apparatus 300 causes the user terminal 500 to display appearance information different from the appearance information for registration together with a message indicating a reason that “There are multiple users with similar clothing (or motion). Please change your clothing to this clothing (or motion).”. At this time, the information processing apparatus 300 may automatically update the appearance information for registration to the displayed appearance information, or may update the appearance information for registration in response to reception of a message indicating acceptance from the user terminal 500. The above-described update of the appearance information for registration is similar even in a case where there is a user U having similar face information for registration or a case where there is a user U having similar face information for registration, and there is a user U having similar or the same appearance information for registration. For example, in a case where the appearance information for registration is registered in response to the registration request of the user U, the information processing apparatus 300 determines whether or not there is a user having similar face information for registration and similar appearance information for registration. Then, the information processing apparatus 300 causes the user terminal 500 to display appearance information different from the appearance information for registration of the user having the similar face information for registration together with a message indicating a reason that “There is a user having a similar face and wearing similar clothing (or making a similar motion). Please change to this clothing (or motion).”. Furthermore, in this case, the information processing apparatus 300 may update the appearance information for registration of the user U to appearance information of a factor type of the appearance information for registration different from that of the user having at least one of similar face information for registration or similar appearance information for registration. For example, in a case where there is another user having similar clothing information to that of the user U, the information processing apparatus 300 updates the appearance information for registration to the motion information. At this time, the information processing apparatus 300 displays the motion information on the user terminal 500 together with a message “There is a user having a similar face and using the clothing information during authentication. Please change the factor used during authentication from the clothing to this motion.”.

Note that the information processing apparatus 300 may cooperate with a point system and store points in association with each user U. The points can be used in a store or a transportation facility, and can be exchanged for a product, for example, or can cover the payment. Then, in a case where the user U has succeeded in personal authentication at a gate, the information processing apparatus 300 may add a predetermined amount of points for the user U. Furthermore, in a case where the user U has registered the appearance information in advance (pre-registration) and the user U has succeeded in personal authentication at a gate, the information processing apparatus 300 may add a predetermined amount of points for the user U. The pre-registration may include a case where the user U requests registration of the appearance information for registration and the appearance information for registration is registered in advance, and a case where the information processing apparatus 300 requests the user U to perform registration in advance and the user U provides the appearance information for registration to the information processing apparatus 300. Furthermore, in a case where the user U has performed the pre-registration and the user U has succeeded in personal authentication at a gate, the information processing apparatus 300 may add a larger amount of points for the user U than that in a case where the user U has not performed the pre-registration by a predetermined amount. By providing an incentive in this manner, the use of the service can be promoted. Note that the incentive is not limited to the points, and may be any benefit.

Furthermore, according to the above-described second and third example embodiments, the face authentication apparatus 100 and the appearance authentication apparatus 200 or 200a are connected to the information processing apparatus 300 via the network N. However, some or all of the functions of the face authentication apparatus 100 and the appearance authentication apparatus 200 may also be included in the information processing apparatus 300. Therefore, at least one of the face information registration processing, the face authentication processing, or the appearance authentication processing may be executed in the information processing apparatus 300.

In the first to third example embodiments described above, the information processing apparatus uses the face authentication result as the first determination result. However, the information processing apparatus may use a result of another biometric authentication instead of or in addition to the face authentication result. In this case, the another biometric authentication is biometric authentication using biometric information that can be acquired by a camera, and may be, for example, iris authentication, palm authentication, fingerprint authentication, human-shape authentication, or skeleton authentication. Furthermore, for example, biometric authentication using a QR code (registered trademark) printed on a card hung on the neck may be performed. In this case, the “face authentication” described above may be replaced with the “biometric authentication”, the “face information” or the “face feature information” may be replaced with the “biometric information” or “biometric feature information”, the “face image” may be replaced with a “biometric image”, and the “face authentication apparatus” may be replaced with a “biometric authentication apparatus”.

Note that, in the above-described example embodiments, the configuration of the hardware has been described, but the present disclosure is not limited thereto. The present disclosure can also be implemented by causing a CPU to execute a computer program.

In the above-described example, the program includes a group of instructions (or software code) for causing a computer to perform one or more functions described in the example embodiments when being read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a CD-ROM, a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communications medium. By way of example, and not limitation, transitory computer-readable or communication media include electrical, optical, acoustic, or other forms of propagated signals.

Some or all of the above-described example embodiments may be described as in the following Supplementary Notes, but are not limited to the following Supplementary Notes.

(Supplementary Note 1)

An information processing apparatus including:
a registration unit configured to register first appearance information for registration in association with face information for registration for each registration target person, and update the first appearance information for registration associated with the face information for registration in a case where a predetermined condition is satisfied;
an acquisition unit configured to acquire captured image data obtained by imaging an authentication target person;
an authentication control unit configured to perform personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration; and
a gate control unit configured to permit passage through a gate in a case where the personal authentication has succeeded.

(Supplementary Note 2)

The information processing apparatus according to Supplementary Note 1, in which the first appearance information is motion information indicating a motion or clothing information indicating clothing.

(Supplementary Note 3)

The information processing apparatus according to Supplementary Note 1 or 2, in which
the first appearance information is the motion information,
the captured image data includes a plurality of frames, and
the face information for authentication and the first appearance information for authentication are generated based on the same frame included in the captured image data.

(Supplementary Note 4)

The information processing apparatus according to any one of Supplementary Notes 1 to 3, in which the registration unit updates the first appearance information for registration associated with the face information for registration in response to a change in type of a gate scheduled to be used by the registration target person.

(Supplementary Note 5)

The information processing apparatus according to any one of Supplementary Notes 1 to 4, in which the registration unit updates the first appearance information for registration associated with the face information for registration in response to passage of the registration target person through the gate.

(Supplementary Note 6)

The information processing apparatus according to any one of Supplementary Notes 1 to 5, in which the registration unit updates the first appearance information for registration associated with the face information for registration of the registration target person in a case where the predicted number of users of the gate scheduled to be used by the registration target person is changed by a predetermined number or more.

(Supplementary Note 7)

The information processing apparatus according to any one of Claims 1 to 6, wherein the registration unit updates the first appearance information for registration associated with the face information for registration of the registration target person whose failure rate of the personal authentication is equal to or higher than a predetermined threshold.

(Supplementary Note 8)

The information processing apparatus according to any one of Supplementary Notes 1 to 7, in which the registration unit updates the first appearance information for registration associated with the face information for registration for each registration target person when a predetermined period has elapsed.

(Supplementary Note 9)

The information processing apparatus according to any one of Supplementary Notes 1 to 8, in which the registration unit sets the first appearance information for registration for each registration target person based on attribute information of the registration target person.

(Supplementary Note 10)

The information processing apparatus according to any one of Supplementary Notes 1 to 9, in which in a case where a similarity between the face information for registration of each registration target person and face information for registration of another registration target person is equal to or higher than a predetermined threshold, the registration unit sets the first appearance information for registration of the registration target person to be different from first appearance information for registration of the another registration target person.

(Supplementary Note 11)

The information processing apparatus according to any one of Supplementary Notes 1 to 10, in which the registration unit sets a first appearance information group including a plurality of pieces of first appearance information for each registration target person, registers first appearance information selected from the first appearance information group as the first appearance information for registration in association with the face information for registration, changes the first appearance information group including the plurality of pieces of first appearance information for the registration target person who satisfies the predetermined condition, and updates the first appearance information for registration to first appearance information selected from the changed first appearance information group.

(Supplementary Note 12)

The information processing apparatus according to any one of Supplementary Notes 1 to 11, in which the registration unit changes the first appearance information group corresponding to the registration target person who satisfies the predetermined condition to a first appearance information group of which the number of pieces of included first appearance information is larger than that of the set first appearance information group, and updates the first appearance information for registration to first appearance information selected from the changed first appearance information group.

(Supplementary Note 13)

The information processing apparatus according to Supplementary Note 11 or 12, in which the registration unit causes each piece of first appearance information included in the first appearance information group to be displayed on a terminal used by the registration target person in such a way as to be selectable by the registration target person.

(Supplementary Note 14)

The information processing apparatus according to any one of Supplementary Notes 1 to 13, in which
the registration unit additionally registers second appearance information for registration that is different from the first appearance information for registration for each registration target person in association with the face information for registration in a case where the predetermined condition is satisfied for each registration target person, and
the authentication control unit performs the personal authentication of the authentication target person based on a third determination result indicating whether or not second appearance information for authentication generated based on the captured image data corresponds to the second appearance information for registration, in addition to the first determination result and the second determination result.

(Supplementary Note 15)

The information processing apparatus according to Supplementary Note 14, in which in a case where the predicted number of users of the gate scheduled to be used by the registration target person is equal to or larger than a predetermined number, the registration unit additionally registers the second appearance information for registration that is different from the first appearance information for registration in association with the face information for registration for the registration target person.

(Supplementary Note 16)

The information processing apparatus according to Supplementary Note 14 or 15, in which the registration unit additionally registers the second appearance information for registration that is different from the first appearance information for registration in association with the face information for registration for the registration target person whose failure rate of the personal authentication is equal to or higher than the predetermined threshold.

(Supplementary Note 17)

An information processing system including:
an authentication terminal configured to generate a captured image obtained by imaging an authentication target person; and
an information processing apparatus communicably connected to the authentication terminal,
wherein the information processing apparatus includes:
a registration unit configured to register first appearance information for registration in association with face information for registration for each registration target person, and update the first appearance information for registration associated with the face information for registration in a case where a predetermined condition is satisfied;
an acquisition unit configured to acquire captured image data obtained by imaging an authentication target person;
an authentication control unit configured to perform personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration; and
a gate control unit configured to permit passage through a gate in a case where the personal authentication has succeeded.

(Supplementary Note 18)

The information processing system according to Supplementary Note 17, in which
the first appearance information is the motion information,
the captured image data includes a plurality of frames, and
the face information for authentication and the first appearance information for authentication are generated based on the same frame included in the captured image data.

(Supplementary Note 19)

An information processing method including:
registering first appearance information for registration in association with face information for registration for each registration target person;
acquiring captured image data obtained by imaging an authentication target person;
performing personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration;
permitting passage through a gate in a case where the personal authentication has succeeded; and
updating the first appearance information for registration associated with the face information for registration in a case where a predetermined condition is satisfied for each registration target person.

(Supplementary Note 20)

A program for causing a computer to execute:
registering first appearance information for registration in association with face information for registration for each registration target person;
acquiring captured image data obtained by imaging an authentication target person;
performing personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration;
permitting passage through a gate in a case where the personal authentication has succeeded; and
updating the first appearance information for registration associated with the face information for registration in a case where a predetermined condition is satisfied for each registration target person.

Although the present invention has been described above with reference to the example embodiments, the present invention is not limited to the above. Various modifications that can be understood by those skilled in the art can be made to the configuration and details of the present invention within the scope of the present invention.

This application claims priority based on Japanese Patent Application No. 2021-029274 filed on Feb. 25, 2021, the entire disclosure of which is incorporated herein.

The information processing apparatus and the information processing system according to the present example embodiment can be used, for example, to manage the entry and exit of a person at an entrance/exit gate.

### REFERENCE SIGNS LIST

10 INFORMATION PROCESSING APPARATUS
11 REGISTRATION UNIT
12 ACQUISITION UNIT
13 AUTHENTICATION CONTROL UNIT
14 GATE CONTROL UNIT
100 FACE AUTHENTICATION APPARATUS
110 FACE INFORMATION DB
111 USER ID
112 FACE FEATURE INFORMATION
120 FACE DETECTION UNIT
130 FEATURE POINT EXTRACTION UNIT
140 REGISTRATION UNIT
150 AUTHENTICATION UNIT
200, 200a APPEARANCE AUTHENTICATION APPARATUS
210 APPEARANCE INFORMATION DB
210-1 FIRST APPEARANCE INFORMATION DB
210-2 SECOND APPEARANCE INFORMATION DB
211 APPEARANCE ID
211-1 FIRST APPEARANCE ID
211-2 SECOND APPEARANCE ID
212 APPEARANCE FEATURE INFORMATION
212-1 FIRST APPEARANCE FEATURE INFORMATION
212-2 SECOND APPEARANCE FEATURE INFORMATION
220, 220a DETECTION UNIT
230, 230a FEATURE POINT EXTRACTION UNIT
240, 240a REGISTRATION UNIT
250, 250a AUTHENTICATION UNIT
300 INFORMATION PROCESSING APPARATUS
310 STORAGE UNIT
311 PROGRAM
313 REGISTRATION HISTORY INFORMATION
314 AUTHENTICATION HISTORY INFORMATION
315 GATE INFORMATION
3151 GATE ID
3152 GATE ATTRIBUTE INFORMATION
316 APPEARANCE-RELATED INFORMATION
3161 APPEARANCE ID
3162 APPEARANCE GROUP ID
320 MEMORY
330 COMMUNICATION UNIT
340 CONTROL UNIT
341 REGISTRATION UNIT
342 ACQUISITION UNIT
343 AUTHENTICATION CONTROL UNIT
344 GATE CONTROL UNIT
400 AUTHENTICATION TERMINAL
410 CAMERA
420 STORAGE UNIT
430 COMMUNICATION UNIT
440 DISPLAY UNIT
450 CONTROL UNIT
451 IMAGING CONTROL UNIT
453 AUTHENTICATION CONTROL UNIT
454 DISPLAY CONTROL UNIT
500 USER TERMINAL
510 CAMERA
520 STORAGE UNIT
530 COMMUNICATION UNIT
540 DISPLAY UNIT
550 CONTROL UNIT
551 IMAGING CONTROL UNIT
552 REGISTRATION UNIT
553 ACQUISITION UNIT
554 DISPLAY CONTROL UNIT
560 INPUT UNIT
600 GATE DRIVING APPARATUS
800, 810, 820 CAPTURED IMAGE
1000 INFORMATION PROCESSING SYSTEM
N NETWORK
U USER

What is claimed is:

1. An information processing apparatus comprising:
at least one memory configured to store instructions, and
at least one processor configured to execute the instructions to:
register first appearance information for registration in association with face information for registration for each registration target person, and updating the first appearance information for registration associated with the face information for registration in a case where a predetermined condition is satisfied;
acquire captured image data obtained by imaging an authentication target person;
perform personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration; and
permit passage through a gate in a case where the personal authentication has succeeded.

2. (canceled)

3. The information processing apparatus according to claim 1, wherein
the first appearance information is the motion information,
the captured image data includes a plurality of frames, and
the face information for authentication and the first appearance information for authentication are generated based on the same frame included in the captured image data.

4. (canceled)

5. The information processing apparatus according to claim 1, wherein the at least one processor is further configured to execute the instructions to update the first appearance information for registration associated with the face information for registration in response to passage of the registration target person through the gate.

6. The information processing apparatus according to claim 1, wherein the at least one processor is further configured to execute the instructions to update the first appearance information for registration associated with the face information for registration of the registration target person in a case where the predicted number of users of the gate scheduled to be used by the registration target person is changed by a predetermined number or more.

7. The information processing apparatus according to claim 1, wherein the at least one processor is further configured to execute the instructions to update the first appearance information for registration associated with the face information for registration of the registration target person whose failure rate of the personal authentication is equal to or higher than a predetermined threshold.

8-9. (canceled)

10. The information processing apparatus according to claim 1, wherein the at least one processor is further configured to execute the instructions to set the first appearance information for registration of the registration target person to be different from first appearance information for registration of the another registration target person, in a case where a similarity between the face information for registration of each registration target person and face information for registration of another registration target person is equal to or higher than a predetermined threshold.

11-13. (canceled)

14. The information processing apparatus according to claim 1, wherein the at least one processor is further configured to execute the instructions to:
additionally register second appearance information for registration that is different from the first appearance information for registration for each registration target person in association with the face information for registration in a case where the predetermined condition is satisfied for each registration target person, and
perform the personal authentication of the authentication target person based on a third determination result indicating whether or not second appearance information for authentication generated based on the captured image data corresponds to the second appearance information for registration, in addition to the first determination result and the second determination result.

15-18. (canceled)

19. An information processing method comprising:
registering first appearance information for registration in association with face information for registration for each registration target person;
acquiring captured image data obtained by imaging an authentication target person;
performing personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration;
permitting passage through a gate in a case where the personal authentication has succeeded; and
updating the first appearance information for registration associated with the face information for registration in a case where a predetermined condition is satisfied for each registration target person.

20. A non-transitory computer-readable medium storing a program for causing a computer to execute:
registering first appearance information for registration in association with face information for registration for each registration target person;
acquiring captured image data obtained by imaging an authentication target person;
performing personal authentication of the authentication target person based on a first determination result indicating whether or not face information for authentication generated based on the captured image data corresponds to the face information for registration and a second determination result indicating whether or not first appearance information for authentication generated based on the captured image data corresponds to the first appearance information for registration;
permitting passage through a gate in a case where the personal authentication has succeeded; and
updating the first appearance information for registration associated with the face information for registration in a case where a predetermined condition is satisfied for each registration target person.
